(19) United States
(12) Patent Application Publication
(10) Pub. No.: US 2021/0302627 A1
(43) Pub. Date: Sep. 30, 2021

(54) EYEPIECE AND DISPLAY APPARATUS

(71) Applicant: Sony Corporation, Tokyo (JP)

(72) Inventors: Mamoru SUZUKI, Tokyo (JP); Takatoshi MATSUYAMA, Tokyo (JP); Susumu ICHIKAWA, Tokyo (JP); Masatoshi NAKAMURA, Tokyo (JP); Mitsuharu MATSUMOTO, Tokyo (JP)

(21) Appl. No.: 17/257,706

(22) PCT Filed: May 30, 2019
(86) PCT No.: PCT/JP2019/021532

§ 371 Date: Jan. 4, 2021

(30) Foreign Application Priority Data
Jul. 9, 2018 (JP) 2018-130078
Mar. 12, 2019 (JP) 2019-044847

(51) Int. Cl. G02B 3/08; G02B 25/00; G02B 13/18; G02B 27/01

(52) U.S. Cl. CPC G02B 3/08; G02B 27/0172; G02B 13/18; G02B 25/001

(57) ABSTRACT

An eyepiece according to the present disclosure includes a first lens and a second lens that are opposed to each other. The first lens includes a first Fresnel lens surface formed at least in a peripheral region of a lens surface that is opposed to the second lens. The second lens includes a second Fresnel lens surface formed at least in a peripheral region of a lens surface that is opposed to the first lens.

### TECHNICAL FIELD

The present disclosure relates to: an eyepiece that magnifies an image (e.g., an image displayed on an image display device); and a display apparatus suitable for a head-mounted display, etc. using such an eyepiece.

### BACKGROUND ART

As a display apparatus using an image display device, an electronic viewfinder, an electronic binocular, a head-mounted display (HMD), etc. are known. Particularly, the head-mounted display is used for a long time with a body of the display apparatus being worn in front of one's eyes. It is therefore required that an eyepiece and the body of the display apparatus be small-sized and light-weighted. In addition, it is required that an image be viewable at a wide viewing angle. In order to reduce a weight and a total length of the eyepiece, there is a technique of using a Fresnel lens (see PTL 1).

### CITATION LIST

### Patent Literature

PTL 1: Japanese Unexamined Patent Application Publication No. H7-244246

PTL 2: Japanese Unexamined Patent Application Publication No. 2015-59959

### SUMMARY OF THE INVENTION

Even if a Fresnel lens is used in an eyepiece, it is not always possible to obtain a sufficient optical effect depending on a surface on which the Fresnel lens is formed, a shape, etc.

It is desirable to provide: an eyepiece that allows for a wide viewing angle and favorable aberration correction while reducing a weight and a total length; and a display apparatus on which such an eyepiece is mounted.

An eyepiece according to an embodiment of the present disclosure includes a first lens and a second lens that are opposed to each other. The first lens includes a first Fresnel lens surface formed at least in a peripheral region of a lens surface that is opposed to the second lens. The second lens includes a second Fresnel lens surface formed at least in a peripheral region of a lens surface that is opposed to the first lens.

A display apparatus according to an embodiment of the present disclosure includes an image display device and an eyepiece that magnifies an image displayed on the image display device. The eyepiece includes the eyepiece according to the embodiment of the present disclosure described above.

The eyepiece or the display apparatus according to the embodiment of the present disclosure includes the first lens and the second lens that are opposed to each other, and a configuration of each of the lenses is optimized with use of a Fresnel lens.

### BRIEF DESCRIPTION OF THE DRAWINGS

FIG. 1 is an explanatory diagram illustrating a first configuration example of an eyepiece optical system to be used, for example, in a head-mounted display.

FIG. 2 is an explanatory diagram illustrating a second configuration example of an eyepiece optical system to be used, for example, in a head-mounted display.

FIG. 3 is an explanatory diagram regarding an image magnification.

FIG. 4 is an explanatory diagram regarding a configuration and workings of a typical Fresnel lens.

FIG. 5 is a lens cross-sectional view of a first configuration example of an eyepiece according to an embodiment of the present disclosure.

FIG. 6 is an explanatory diagram regarding a shape of a Fresnel lens.

FIG. 7 is an explanatory diagram illustrating comparison of a total length and a weight between an eyepiece according to a comparative example and the eyepiece according to the first configuration example of the present disclosure.

FIG. 8 is an explanatory diagram illustrating a first example of a method of forming a Fresnel lens surface.

FIG. 9 is an explanatory diagram illustrating a second example of the method of forming the Fresnel lens surface.

FIG. 10 is an explanatory diagram illustrating an example of a relationship between an annular-section height of the Fresnel lens surface and luminance unevenness in the eyepiece according to the first configuration example.

FIG. 11 is an explanatory diagram regarding a reason why the luminance unevenness varies in accordance with the annular-section height of the Fresnel lens surface in the eyepiece according to the first configuration example.

FIG. 12 is a partially-enlarged diagram illustrating, in an enlarged manner, opposed parts of two Fresnel lens surfaces illustrated in FIG. 11.

FIG. 13 is an explanatory diagram illustrating an example of an illuminance distribution of stray light in the eyepiece according to the first configuration example.

FIG. 14 is an explanatory diagram illustrating an example of a path of the stray light in the eyepiece according to the first configuration example.

FIG. 15 is a partially-enlarged diagram illustrating, in an enlarged manner, opposed parts of two Fresnel lens surfaces illustrated in FIG. 14.

FIG. 16 is an explanatory diagram illustrating an example of a relationship between step-surface angles of the two Fresnel lens surfaces and an illumination distribution of stray light in the eyepiece according to the first configuration example.

FIG. 17 is an explanatory diagram illustrating an example of a relationship between step-surface angles of two Fresnel lens surfaces and an illumination distribution of stray light in the eyepiece according to the second configuration example.

FIG. 18 is an explanatory diagram illustrating an example of a visibility state of annular lines in a virtual image plane of an optical system using the typical Fresnel lens.

FIG. 19 is an explanatory diagram illustrating an overview of a principle of generation of the annular lines.

FIG. 20 is an explanatory diagram illustrating an example of a typical method of improving the visibility state of the annular lines.

FIG. 21 is a lens cross-sectional view of a fifth configuration example of the eyepiece according to the embodiment.

FIG. 22 is an explanatory diagram illustrating an example of the visibility state of the annular lines in the eyepiece according to the fifth configuration example.

FIG. 23 is a lens cross-sectional view of a configuration example of an eyepiece according to a comparative example for the eyepiece according to the fifth configuration example.

FIG. 24 is an explanatory diagram illustrating a configuration example of the annular sections of the first Fresnel lens surface and the second Fresnel lens surface in the eyepiece according to the fifth configuration example, together with a comparative example.

FIG. 25 is an explanatory diagram illustrating an example of a sag amount of an aspherical shape to be a base for forming the first Fresnel lens surface in the eyepiece according to the fifth configuration example, together with a comparative example.

FIG. 26 is an explanatory diagram illustrating an example of a sag amount of an aspherical shape to be a base for forming the second Fresnel lens surface in the eyepiece according to the fifth configuration example, together with a comparative example.

FIG. 27 is an explanatory diagram illustrating a desirable configuration example of the annular sections of the first Fresnel lens surface and the second Fresnel lens surface in the eyepiece according to the fifth configuration example.

FIG. 28 is a lens cross-sectional view of an eyepiece according to Example 1-1.

FIG. 29 is an aberration diagram illustrating spherical aberration of the eyepiece according to Example 1-1.

FIG. 30 is an aberration diagram illustrating field curvature and distortion of the eyepiece according to Example 1-1.

FIG. 31 is a lens cross-sectional view of an eyepiece according to Example 1-2.

FIG. 32 is an aberration diagram illustrating spherical aberration of the eyepiece according to Example 1-2.

FIG. 33 is an aberration diagram illustrating field curvature and distortion of the eyepiece according to Example 1-2.

FIG. 34 is a lens cross-sectional view of an eyepiece according to Example 1-3.

FIG. 35 is an aberration diagram illustrating spherical aberration of the eyepiece according to Example 1-3.

FIG. 36 is an aberration diagram illustrating field curvature and distortion of the eyepiece according to Example 1-3.

FIG. 37 is a lens cross-sectional view of an eyepiece according to Example 1-4.

FIG. 38 is an aberration diagram illustrating spherical aberration of the eyepiece according to Example 1-4.

FIG. 39 is an aberration diagram illustrating field curvature and distortion of the eyepiece according to Example 1-4.

FIG. 40 is a lens cross-sectional view of an eyepiece according to Example 1-5.

FIG. 41 is an aberration diagram illustrating spherical aberration of the eyepiece according to Example 1-5.

FIG. 42 is an aberration diagram illustrating field curvature and distortion of the eyepiece according to Example 1-5.

FIG. 43 is a lens cross-sectional view of an eyepiece according to Example 1-6.

FIG. 44 is an aberration diagram illustrating spherical aberration of the eyepiece according to Example 1-6.

FIG. 45 is an aberration diagram illustrating field curvature and distortion of the eyepiece according to Example 1-6.

FIG. 46 is a lens cross-sectional view of an eyepiece according to Example 1-7.

FIG. 47 is an aberration diagram illustrating spherical aberration of the eyepiece according to Example 1-7.

FIG. 48 is an aberration diagram illustrating field curvature and distortion of the eyepiece according to Example 1-7.

FIG. 49 is a lens cross-sectional view of an eyepiece according to Example 1-8.

FIG. 50 is an aberration diagram illustrating spherical aberration of the eyepiece according to Example 1-8.

FIG. 51 is an aberration diagram illustrating field curvature and distortion of the eyepiece according to Example 1-8.

FIG. 52 is a lens cross-sectional view of an eyepiece according to Example 2.

FIG. 53 is an aberration diagram illustrating spherical aberration of the eyepiece according to Example 2.

FIG. 54 is an aberration diagram illustrating field curvature and distortion of the eyepiece according to Example 2.

FIG. 55 is a lens cross-sectional view of an eyepiece according to Example 3.

FIG. 56 is an aberration diagram illustrating spherical aberration of the eyepiece according to Example 3.

FIG. 57 is an aberration diagram illustrating field curvature and distortion of the eyepiece according to Example 3.

FIG. 58 is a lens cross-sectional view of an eyepiece according to Example 4.

FIG. 59 is an aberration diagram illustrating spherical aberration of the eyepiece according to Example 4.

FIG. 60 is an aberration diagram illustrating field curvature and distortion of the eyepiece according to Example 4.

FIG. 61 is a lens cross-sectional view of an eyepiece according to Example 5.

FIG. 62 is an aberration diagram illustrating spherical aberration of the eyepiece according to Example 5.

FIG. 63 is an aberration diagram illustrating field curvature and distortion of the eyepiece according to Example 5.

FIG. 64 is a lens cross-sectional view of an eyepiece according to Example 6.

FIG. 65 is an aberration diagram illustrating spherical aberration of the eyepiece according to Example 6.

FIG. 66 is an aberration diagram illustrating field curvature and distortion of the eyepiece according to Example 6.

FIG. 67 is a lens cross-sectional view of an eyepiece according to Example 7.

FIG. 68 is an aberration diagram illustrating spherical aberration of the eyepiece according to Example 7.

FIG. 69 is an aberration diagram illustrating field curvature and distortion of the eyepiece according to Example 7.

FIG. 70 is a lens cross-sectional view of an eyepiece according to Example 8.

FIG. 71 is an aberration diagram illustrating spherical aberration of the eyepiece according to Example 8.

FIG. 72 is an aberration diagram illustrating field curvature and distortion of the eyepiece according to Example 8.

FIG. 73 is an external perspective view of a head-mounted display as an example of a display apparatus, viewed obliquely from the front.

FIG. 74 is an external perspective view of the head-mounted display as the example of the display apparatus, viewed obliquely from the back.

### MODES FOR CARRYING OUT THE INVENTION

In the following, embodiments of the present disclosure are described in detail with reference to the drawings. Note that the description is given in the following order.

0. Comparative Example

1. Overview of Eyepiece According to Embodiment (Basic Configuration of Eyepiece)

2. Configuration Examples, Workings, and Effects of Eyepiece According to Embodiment

3. Example of Application to Display Apparatus

4. Numerical Examples of Lenses

5. Other Embodiments

### 0. Comparative Example

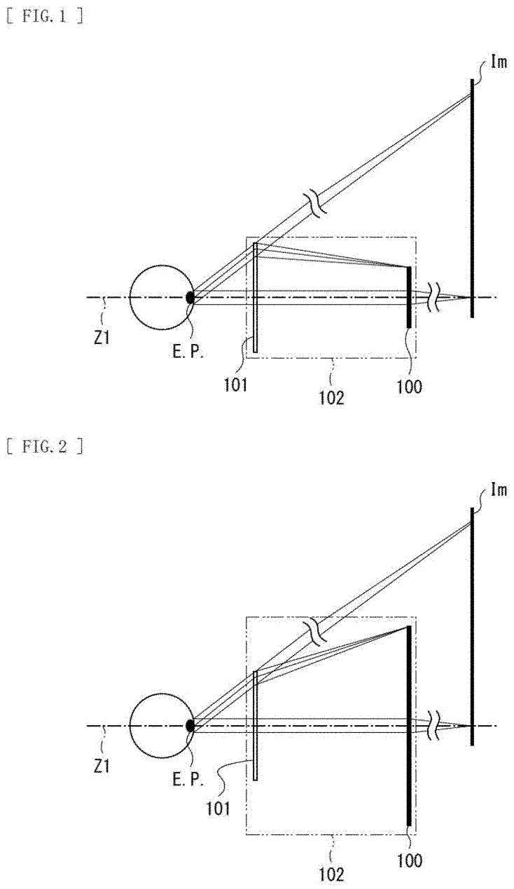

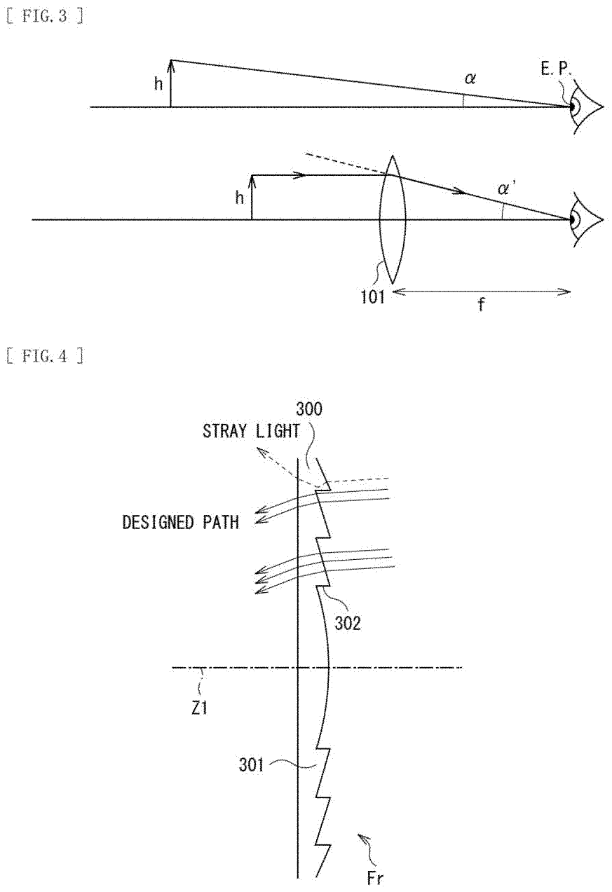

FIG. 1 illustrates a first configuration example of an eyepiece optical system 102 to be used, for example, in a head-mounted display. FIG. 2 illustrates a second configuration example of the eyepiece optical system 102 to be used, for example, in a head-mounted display.

The eyepiece optical system 102 includes an eyepiece 101 and an image display device 100 in order from an eye point E.P. side along an optical axis Z1.

The image display device 100 is, for example, a display panel such as an LCD (Liquid Crystal Display) or an organic EL display. The eyepiece 101 is used to magnify and display an image displayed on the image display device 100. With use of the eyepiece 101, a viewer views a virtual image Im that is displayed in a magnified manner. A sealing glass, etc. adapted to protect the image display device 100 may be disposed on a front surface of the image display device 100. The eye point E.P. corresponds to a position of a pupil of the viewer and also serves as an aperture stop STO.

Here, FIG. 1 illustrates a configuration example in a case where a size of the image display device 100 is smaller than a lens diameter of the eyepiece 101. FIG. 2 illustrates a configuration example in a case where the size of the image display device 100 is larger than the lens diameter of the eyepiece 101.

In a head-mounted display that has a great viewing angle over 70° and uses the coaxial eyepiece optical system 102, the image display device 100 is often larger than the lens diameter of the eyepiece 101. In such a head-mounted display, although an image magnification Mv can be suppressed to be small, a focal length f becomes relatively long. This leads to a concern that the eyepiece optical system 102 has a long total length. Further, the size of the eyepiece optical system 102 is sometimes limited not by the size of the eyepiece 101 but by the size of the image display device 100. This further leads to an issue of unsuitableness for reduction in size.

For example, as illustrated in FIG. 1, in a case where the size of the image display device 100 is small, the size of the eyepiece optical system 102 as a whole is limited by the size of the eyepiece 101. In contrast, as illustrated in FIG. 2, in a case where the size of the image display device 100 is large, the size of the eyepiece optical system 102 as a whole is limited by the size of the image display device 100.

Note that the image magnification Mv is expressed by Mv=α′/α. As illustrated in an upper part of FIG. 3, a represents the viewing angle in a case where the eyepiece 101 is not provided. Further, as illustrated in a lower part of FIG. 3, a′ represents the viewing angle (the viewing angle with respect to the virtual image Im) in a case where the eyepiece 101 is provided. In FIG. 3, his a maximum image height of the image to be viewed, and is, for example, a maximum image height of an image displayed on the image display device 100. For example, in a case where the image display device 100 has a rectangular shape, h is a half value of a diagonal size of the image display device 100. f represents a focal length of the eyepiece 101.

Further, the image magnification Mv is expressed by the following expression (A),

Mv=ω′/(tan⁻¹(h/L)) (A)
where ω′ is a half value (rad) of a maximum viewing angle,
h is the maximum image height, and
L is a total length (a distance from the eye point E.P. to an image).

Note that the image refers to an image displayed on the image display device 100, for example. For example, in the case where the image display device 100 has the rectangular shape, h is the half value of the diagonal size of the image display device 100, as described above. L corresponds to the total length of the eyepiece optical system 102 described above (a distance from the eye point E.P. to a display surface of the image display device 100), for example.

Setting the image magnification My to a high magnification of 2.1 or more and setting the size of the image display device 100 to be smaller with respect to the lens diameter of the eyepiece 101 as in the configuration example illustrated in FIG. 1 make it is possible to reduce a volume occupied by the eyepiece optical system 102. In such a case, however, because of the high magnification, various aberrations including field curvature and distortion are generated in great amounts. Therefore, in order to secure adequate image definition, for example, it can be necessary to provide at least three lenses in the eyepiece 101. Accordingly, there is an issue of an increase in weight or total length of the eyepiece 101.

To address this, a method of using a Fresnel lens is widely known as a means for reducing the weight or the total length of the eyepiece 101. PTL 1 (Japanese Unexamined Patent Application Publication No. H7-244246) discloses a technique related to an eyepiece optical system of a high-magnification head-mounted display using a Fresnel lens. The technique disclosed in PTL 1 achieves the reduction in weight and total length with use of the Fresnel lens, as compared with an eyepiece optical system using a standard lens. In the technique described in PTL 1, an image formation performance is enhanced by providing a most-eye-side lens surface with a concave shape and causing the most-eye-side lens surface to have a Fresnel lens surface. Therefore, there is an issue that the total length of the eyepiece optical system becomes longer or the lens diameter becomes larger in order to secure a sufficient distance between an eye and the most-eye-side lens.

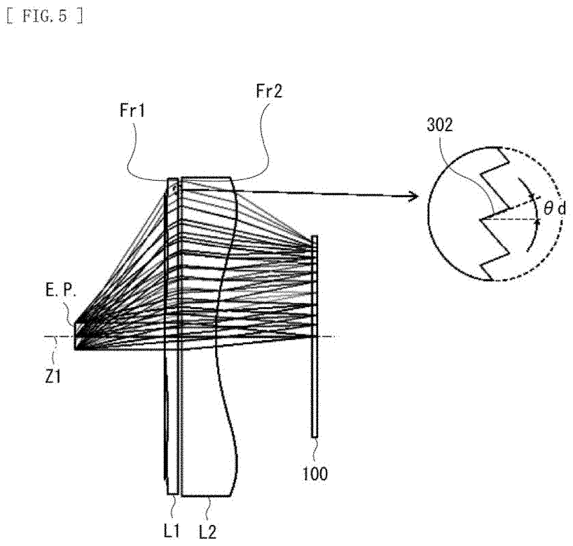

Here, FIG. 4 illustrates a configuration and a working of a typical Fresnel lens 300.

The Fresnel lens 300 has two or more annular sections 301 formed concentrically about the optical axis Z1. The annular sections 301 each have a border part on which a step surface 302 is formed. The Fresnel lens 300 has a Fresnel lens surface Fr having a sawtooth-shaped cross-section.

As illustrated in FIG. 4, an eyepiece optical system using the Fresnel lens 300 involves generation of stray light in a direction that differs from a design path due to the step surface 302. This stray light is visually recognized as a ghost or a flare, leading to an issue of deterioration in image quality (in particular, contrast). As a means for reducing this stray light, there is a method of forming a light-blocking layer on the step surface 302 as in a technique described in PTL 2 (Japanese Unexamined Patent Application Publication No. 2015-59959). The light-blocking layer absorbs visible light. However, this method involves issues of difficulty in process, difficulty in highly-precise film formation, and an increase in manufacturing cost due to an increase in number of processes.

As described above, even if the Fresnel lens is used in the eyepiece, it is not always possible to obtain a sufficient optical effect depending on a surface on which the Fresnel lens is formed, a shape, etc.

Therefore, it is desired to develop an eyepiece that allows for a wide viewing angle and favorable aberration correction while reducing a weight and a total length with use of the Fresnel lens.

### 1. Overview of Eyepiece According to Embodiment (Basic Configuration of Eyepiece)

An eyepiece according to an embodiment of the present disclosure is applicable to, for example, the eyepiece optical system 102 of a head-mounted display, as with the comparative example described above.

The eyepiece according to the embodiment of the present disclosure includes a first lens and a second lens that are opposed to each other. The first lens includes a first Fresnel lens surface Fr1 formed at least in a peripheral region of a lens surface that is opposed to the second lens. The second lens includes a second Fresnel lens surface Fr1 formed at least in a peripheral region of a lens surface that is opposed to the first lens. Using two Fresnel lenses and so disposing the first Fresnel lens surface Fr1 and the second Fresnel lens surface Fr2 that the first Fresnel lens surface Fr1 and the second Fresnel lens surface Fr2 are opposed to each other make it possible to achieve an optical system having a short total length.

It is preferable that the eyepiece according to the embodiment of the present disclosure satisfy a conditional expression (1) to have the image magnification My of 2.1 or greater, and be applied to the eyepiece optical system 102 in which the size of the image display device 100 is smaller than the lens diameter of the eyepiece 101 as in the configuration example illustrated in FIG. 1.

Mv≥2.1 (1)

Further, as in first to fourth configuration examples described later, it is preferable that a step-surface angle θd of the first Fresnel lens surface Fr1 and the second Fresnel lens surface Fr2 with respect to the optical axis Z1 be a predetermined angle (e.g., 15° or 20°) or greater. This contributes to suppress generation of stray light, and to reduce generation of a ghost or a flare.

Alternatively, as in fifth to eighth configuration examples described later, it is preferable to provide a configuration that improves a visibility state of the annular section 301 in the first Fresnel lens surface Fr1 and the second Fresnel lens surface Fr2 with respect to the first to the fourth configuration examples.

The eyepiece according to the embodiment of the present disclosure can be used for a small and high-resolution image display device 100 such as an image display device 100 of 4k having a size of 1.5 inches or less, for example. This makes it possible to secure a wide viewing angle and high image definition while reducing a weight and a total length. Moreover, it is possible to suppress generation of a flare or a ghost, making it possible to provide a high-contrast visual image.

### 2. Configuration Examples, Workings, and Effects of Eyepiece According to Embodiment

A description is given below of the first to the fourth configuration examples that satisfy the above-described basic configuration of the eyepiece. In addition, the fifth to the eighth configuration examples in which the visibility state of the annular section 301 is improved compared with the first to the fourth configuration examples are described.

### Definition of Terms

Note that, in the following configuration examples and the following Examples, an i-th lens from an eye side (the eye point E.P. side) is referred to as Li. For example, a lens closest to the eye side is referred to as a first lens L1. Further, regarding each lens, a surface on the eye point E.P. side is referred to as an R1 surface, and a surface on an image side (an image display device 100 side) that is magnified by the eyepiece is referred to as an R2 surface. For example, a surface, of the first lens L1, on the eye point E.P. side is referred to as an L1 (R1) surface, a surface, of the first lens L1, on the image side is referred to as an L1(R2) surface, and so on.

Further, in the following configuration examples and the following Examples, a usual lens surface which is not a Fresnel lens surface is referred to as a standard lens surface. The standard lens surface encompasses not only a spherical surface but also aspherical surfaces other than that having a Fresnel shape.

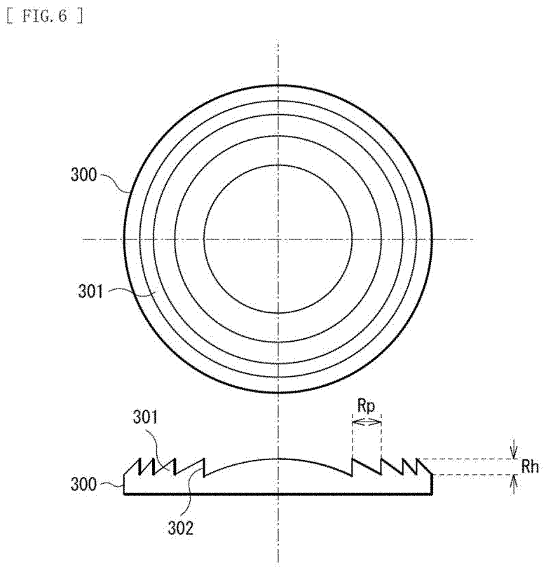

Further, in the following configuration examples and the following Examples, as with the Fresnel lens 300 illustrated in FIGS. 4 and 6, a surface that is not an effective lens surface in the Fresnel lens surface Fr is referred to as a step surface (the step surface 302). In the Fresnel lens surface Fr, a height of each of the annular sections 301 divided concentrically is referred to as an “annular-section height” (an annular-section height Rh), and a distance between vertices of two adjacent annular sections 301 is referred to as an “annular-section pitch” (an annular-section pitch Rp).

Further, an on-axial distance between the eye point E.P. and the lens surface (the L1(R1) surface), of the eyepiece, that is closest to the eye point E.P. side is referred to as an “eye relief” (eye relief E.R.).

### (Conditions for Simulation of Stray Light Generation Amount)

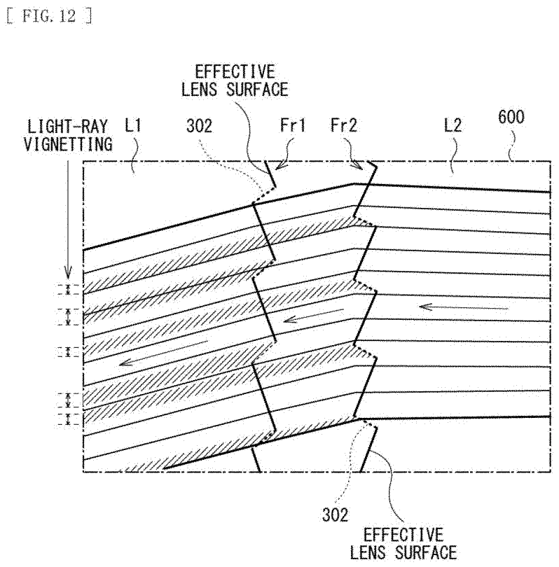

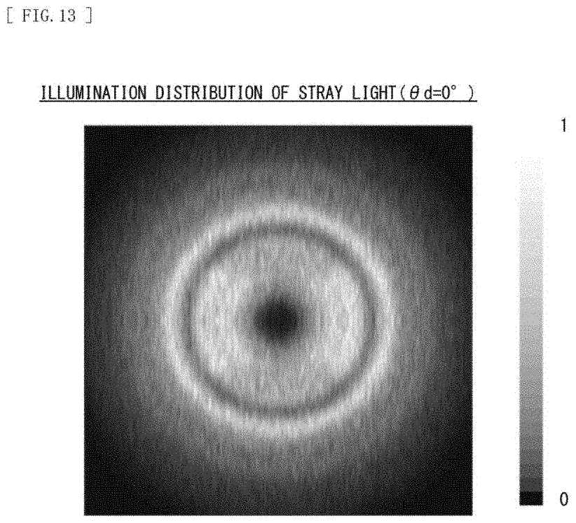

Calculation for simulations (FIGS. 13, 16, and 17) of a generation amount of stray light (an illuminance distribution) was made under the following conditions unless otherwise specified.
A light distribution characteristic of the image display device 100: Lambertian
The size of the image display device 100: 17 mm×27 mm (vertical×horizontal)
A pupil diameter: φ 4 mm
A shape of the Fresnel lens surface: Annular-section height Rh=100 μm (constant) (An annular-section pitch Rp is unequal)
A reference wavelength: 587.6 nm (d-line)

### First Configuration Example

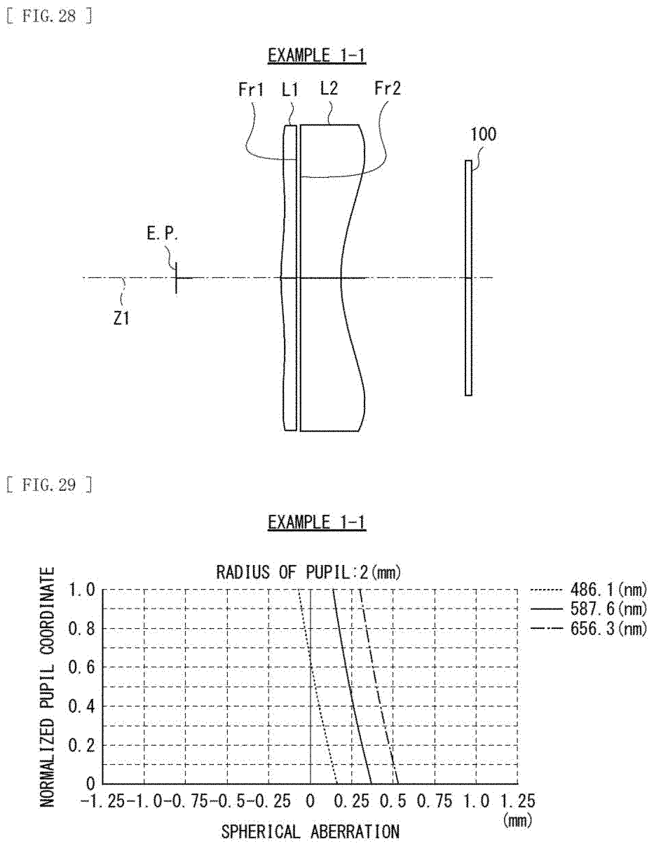

FIG. 5 illustrates a first configuration example of the eyepiece according to the embodiment. This first configuration example corresponds to configurations (FIG. 28, etc.) of eyepieces according to Examples 1-1 to 1-8 described later.

The eyepiece according to the first configuration example of the present disclosure has a two-group two-lens configuration in which a first lens L1 and a second lens L2 are disposed in order from the eye point E.P. side toward the image side.

The first Fresnel lens surface Fr1 is formed in an entire region from a center to a periphery of a lens surface (a L1 (R2) surface), of the first lens L1, that is opposed to the second lens L2.

The second Fresnel lens surface Fr2 is formed in an entire region from a center to a periphery of a lens surface (a L2(R1) surface), of the second lens L2, that is opposed to the first lens L1.

Further, it is preferable that the first lens L1 include a lens surface (L1(R1) surface) on the eye point E.P. side that has a convex shape or a planar shape. This makes it possible to secure a long eye relief E.R., which achieves an easier-to-view structure. For example, in a concave lens having a great power, even if a certain degree of eye relief E.R. is secured, an edge part of the lens interferes with the eye, causing an adverse effect of difficulty in viewing.

Further, it is preferable that the step-surface angle θd of the first Fresnel lens surface Fr1 and the second Fresnel lens surface Fr2 with respect to the optical axis Z1 be 15° or greater.

Further, it is preferable that the first Fresnel lens surface Fr1 and the second Fresnel lens surface Fr2 each have positive refractive power. This makes it possible to efficiently correct various aberrations, making it possible to reduce the total length and the weight.

Further, it is preferable that the first lens L1, the second lens L2, or both include an aspherical surface having an inflection point. In the first lens L1 and the second lens L2, using one or more aspherical surfaces for a surface other than the first Fresnel lens surface Fr1 and the second Fresnel lens surface Fr2, and providing the one or more aspherical surfaces with an inflection point make it possible to efficiently correct astigmatism, field curvature, and distortion with small number of lenses. Further, providing the aspherical shape with the inflection point makes it possible to efficiently correct distortion.

Further, it is preferable that the following conditional expression (2) be satisfied to have a refractive index nd of 1.7 or less, where nd is a refractive index of each of the first lens L1 and the second lens L2 with respect to the d-line. This makes it possible to reduce the weight of the eyepiece.

nd≤1.7 (2)

Further, it is preferable that

ψ1≤ψ2 (3)

be satisfied where ψ1 is refractive power of the first Fresnel lens surface Fr1, and ψ2 is refractive power of the second Fresnel lens surface Fr2. This makes it possible to efficiently correct various aberrations, making it possible to reduce the total length and the weight.

Note that the refractive power ψ1 is expressed by (nd1−1)/R1, where nd1 is a refractive index of the first Fresnel lens surface Fr1 with respect to the d-line, and R1 is a curvature radius of the first Fresnel lens surface Fr1. The refractive power ψ2 is expressed by (nd2−1)/R2, where nd2 is a refractive index of the second Fresnel lens surface Fr2 with respect to the d-line, and R2 is a curvature radius of the second Fresnel lens surface Fr2.

In terms of easy processing of the Fresnel lens surface and the aspherical surface, it is desirable to use a resin material such as an acrylic-based material, a polyolefin-based material, or polycarbonate as the material of the first lens L1 and the second lens L2. Configuring the first lens L1 and the second lens L2 only with use of the resin material, it is possible to reduce the weight and the size, as compared with a case of a configuration including one or more glass lenses. A reason for this is that a glass material with a high refractive index used to gain refractive power is replaceable with a thin and light-weighted Fresnel lens.

### (Effects of Fresnel Lens Surfaces Opposed to Each Other)

As described above, the eyepiece according to the first configuration example of the present disclosure is characterized in that the two Fresnel lens surfaces, i.e., the first Fresnel lens surface Fr1 and the second Fresnel lens surface Fr2 are opposed to each other. A reason for this is described below.

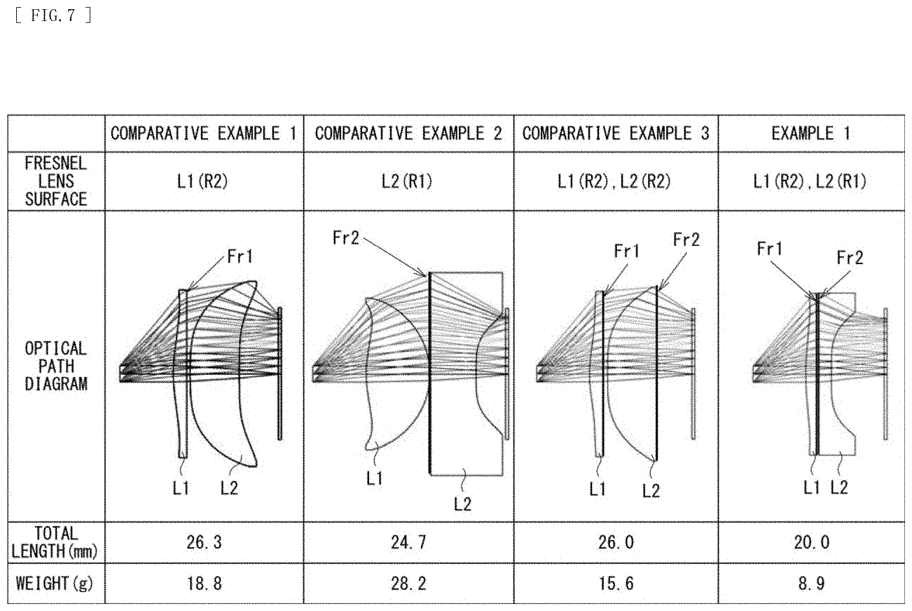

FIG. 7 illustrates the eyepieces according to Comparative examples 1 to 3 and the eyepiece according to the first configuration example of the present disclosure (Example 1), comparing the eyepieces in terms of total length and weight.

In FIG. 7, the eyepiece according to Comparative example 1 has a configuration in which the Fresnel lens surface (the first Fresnel lens surface Fr1) is formed only on the L1(R2) surface of the first lens L1. The eyepiece according to Comparative example 2 has a configuration in which the Fresnel lens surface (the second Fresnel lens surface Fr2) is formed only on the L2(R1) surface of the second lens L2. The eyepiece according to Comparative example 3 has a configuration in which two Fresnel lens surfaces are formed on the L1(R2) surface of the first lens L1 and the L2(R2) surface of the second lens L2 without being opposed to each other.

Specifications of the eyepieces according to Comparative examples 1 to 3 and Example 1 in FIG. 7 are as follows.

The maximum FOV (Field of view): 100°

The eye relief E.R.: 13 mm

The size of the image display device 100: 17 mm×27 mm (vertical×horizontal)

Referring to FIG. 7, it is understood that the total length and the lens weight are allowed to be minimized by providing each of the L1(R2) surface of the first lens L1 and the L2(R1) surface of the second lens L2 with the Fresnel lens surface. A reason for this is that the use of the Fresnel lenses for the L1 (R2) surface and the L2(R1) surface that require refractive power makes it possible to refract light rays efficiently in terms of space.

The eyepiece according to the first configuration example of the present disclosure minimizes the total length and the lens weight. In addition thereto, the eyepiece according to the first configuration example of the present disclosure is an image-side telecentric optical system, making it possible to suppress sensitivity to eccentricity of the lens, the image display device 100, etc. to be low. Furthermore, it is also possible to reduce luminance unevenness, color unevenness, etc. caused by the viewing angle characteristic of the image display device 100, providing an advantage also in terms of image quality as compared with other configurations.

(Regarding Method of Dividing Fresnel Lens Surface into Annular Sections (Forming Method))

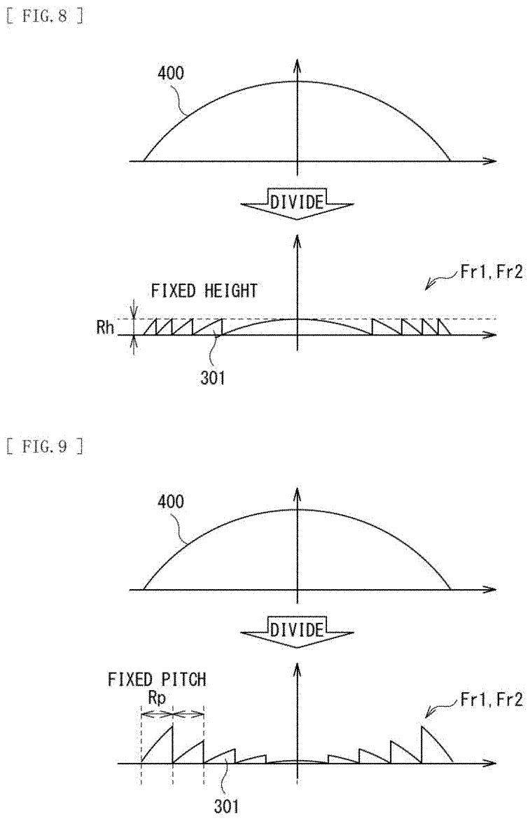

FIG. 8 illustrates a first example of a method of forming the first Fresnel lens surface Fr1 and the second Fresnel lens surface Fr2. FIG. 9 illustrates a second example of the method of forming the first Fresnel lens surface Fr1 and the second Fresnel lens surface Fr2.

In the first forming method illustrated in FIG. 8, a convex lens 400 is concentrically divided to so form two or more annular sections 301 that the annular-section height Rh is constant (the annular-section pitch Rp is unequal). In the second forming method illustrated in FIG. 9, the convex lens 400 is concentrically divided to so form two or more annular sections 301 that the annular-section pitch Rp is constant (the annular-section height Rh is unequal).

Regarding the eyepiece according to the present disclosure, it is preferable to so form the annular sections 301 that the annular-section height Rh is constant, as in the first forming method illustrated in FIG. 8. A reason for this is that, as compared with a structure having the constant annular-section pitch Rp as in the second forming method illustrated in FIG. 9, a central region of the lens is not divided, making it possible to secure image quality of the central region of the field of view which is important in the head-mounted display, etc.

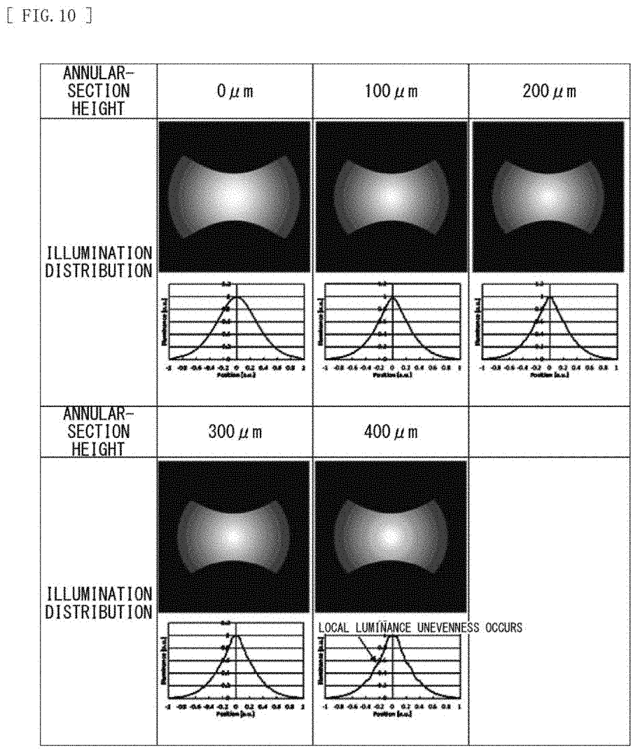

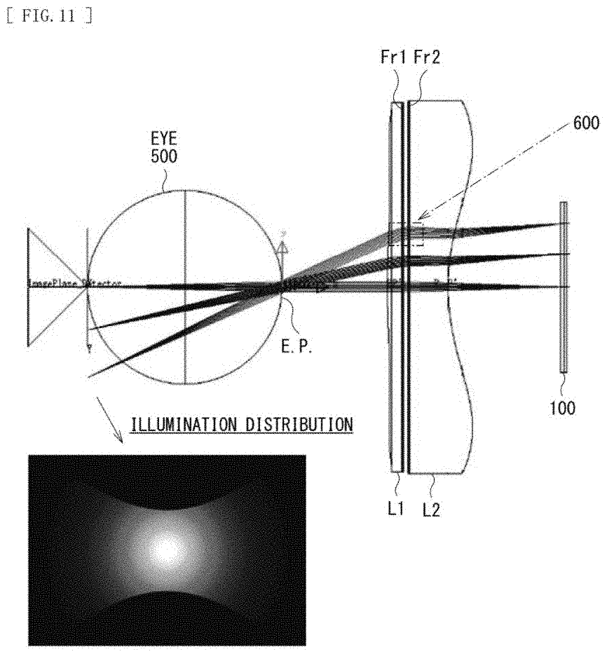

Further, an optimal annular-section height Rh is described. FIG. 10 illustrates an example of a relationship between the annular-section height of the Fresnel lens surface and the luminance unevenness in the eyepiece according to the first configuration example. FIG. 11 is an explanatory diagram regarding a reason why the luminance unevenness varies depending on the annular-section height of the Fresnel lens surface in the eyepiece according to the first configuration example. FIG. 12 illustrates, in an enlarged manner, a region 600 of a part of the opposed parts of the first Fresnel lens surface Fr1 and the second Fresnel lens surface Fr2 illustrated in FIG. 11.

FIG. 10 illustrates a result of analyzing an illumination distribution in a virtual image plane when performing full-white display on the image display device 100, and illustrates annular-section height Rh dependence of the illuminance distribution. It can be appreciated that more luminance unevenness is generated in accordance with an increase in the annular-section height Rh. A reason for this is that, as illustrated in the region 600 in FIGS. 11 and 12, an area of a bundle of light rays passing through the step surfaces 302 of the first Fresnel lens surface Fr1 and the second Fresnel lens surface Fr2 differs depending on the image height, due to an influence of vignetting of light rays caused by the step surfaces 302, and the area of the bundle of light rays passing through the step surface 302 increases in accordance with an increase in the annular-section height Rh.

Referring to FIG. 10, remarkable luminance unevenness is observed in a case of over 400 μm. It is therefore desirable that the annular-section height Rh be about 400 μm or less. However, if the annular sections 301 are provided at excessively small pitches, there is an issue of low definition resulting from an influence of spreading of light caused by diffraction. In order not to impair the definition by the diffraction, it is desirable that annular-section height Rh be about 20 μm or greater.

### (Regarding Step Surface of Annular Section)

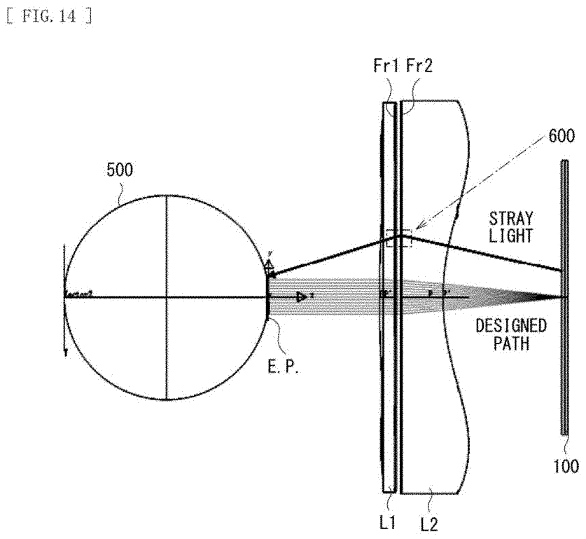

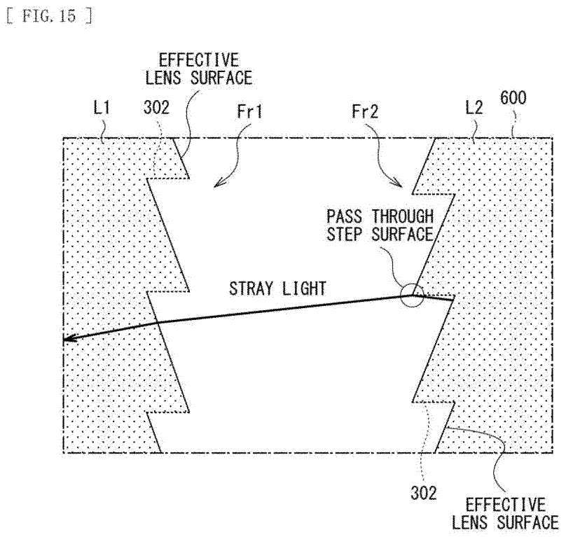

FIG. 13 illustrates an example of an illuminance distribution of stray light in the eyepiece according to the first configuration example. FIG. 14 illustrates an example of a path of the stray light in the eyepiece according to the first configuration example. FIG. 15 illustrates, in an enlarged manner, the region 600 of a part of the opposed parts of the two Fresnel lens surfaces illustrated in FIG. 14.

Varying a gradient angle (the step-surface angle θd) of the step surface 302 of the annular section 301 on the first Fresnel lens surface Fr1 and the second Fresnel lens surface Fr2 makes it possible to reduce an amount of stray light entering an eye 500. FIG. 13 illustrates a result of extracting only a stray light component in the illuminance distribution of the virtual image plane in a case where the step-surface angle θd of each of the first Fresnel lens surface Fr1 and the second Fresnel lens surface Fr2 is set to 0° and white display is performed on the image display device 100 in the eyepiece according to the first configuration example of the present disclosure.

Note that, because the stray light is a factor of a flare or a ghost, it is ideally desirable that no stray light be generated, that is, it is desirable that the amount of the stray light be 0. FIGS. 14 and 15 illustrate results of analyzing a dominant path of this stray light. Referring to FIGS. 14 and 15, it can be appreciated that the stray light is a component that enters the eye 500 via the step surface 302. That is, appropriately setting the step surface 302 makes it possible to reduce an amount of the stray light entering the eye 500.

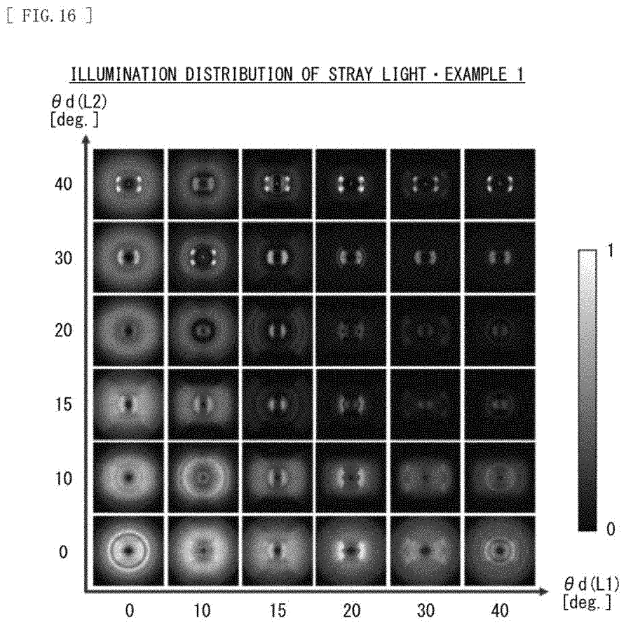

FIG. 16 illustrates an example of a relationship between step-surface angles θd(L1) and θd(L2) of the two Fresnel lens surfaces and an illuminance distribution of the stray light in the eyepiece according to the first configuration example (Example 1). Note that, in FIG. 16, θd(L1) is the step-surface angle of the first Fresnel lens surface Fr1, and θd(L2) is the step-surface angle of the second Fresnel lens surface Fr2.

FIG. 16 illustrates a result of calculating the illuminance distribution of the stray light on the virtual image plane in a case where the step-surface angle θd(L1) of the first Fresnel lens surface Fr1 and the step-surface angle θd(L2) of the second Fresnel lens surface Fr2 are varied. Referring to FIG. 16, regarding the eyepiece according to the first configuration example, setting each of the step-surface angles θd(L1) and θd(L2) to an angle of 15° or greater makes it possible to reduce the dominant stray light, making it possible to provide a high-contrast visual image.

### Second Configuration Example

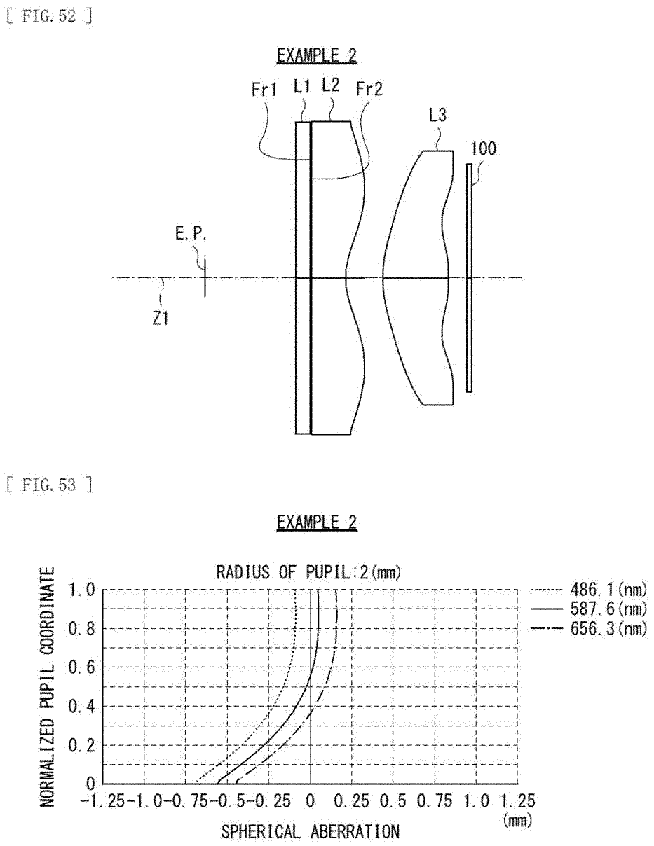

An eyepiece according to a second configuration example of the present disclosure corresponds to a configuration (FIG. 52) of an eyepiece according to Example 2 described later.

Compared with the eyepiece according to the first configuration example described above, the eyepiece according to the second configuration example of the present disclosure has a configuration that further includes a third lens L3 disposed closer to the image side than the first lens L1 and the second lens L2. That is, the eyepiece according to the second configuration example of the present disclosure has a three-group three-lens configuration in which the first lens L1, the second lens L2, and the third lens L3 are disposed in order from the eye point E.P. side toward the image side.

The third lens L3 is a standard lens in which no Fresnel lens surface is used. It is preferable that the third lens L3 be an aspherical lens on which an aspherical surface having an inflection point is formed on at least one surface.

In a manner approximately similar to that of the eyepiece according to the first configuration example, the eyepiece according to the second configuration example of the present disclosure includes the first Fresnel lens surface Fr1 and the second Fresnel lens surface Fr2 that are opposed to each other in the first lens L1 and the second lens L2.

Compared with the eyepiece according to the first configuration example, the eyepiece according to the second configuration example of the present disclosure is increased in weight, total length of the optical system, etc. by the addition of the third lens L3; however, more adequate aberration correction is allowed, making it possible to provide a high-definition image, as described later in Example 2.

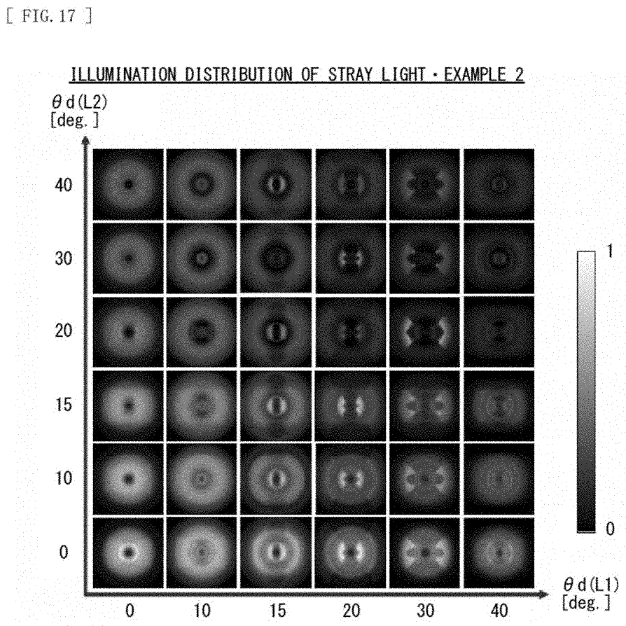

FIG. 17 illustrates an example of a relationship between the step-surface angles θd(L1) and θd(L2) of the two Fresnel lens surfaces and the illuminance distribution of the stray light in the eyepiece according to the second configuration example (Example 2). Note that, in FIG. 17, θd(L1) is the step-surface angle of the first Fresnel lens surface Fr1, and θd(L2) is the step-surface angle of the second Fresnel lens surface Fr2.

FIG. 17 illustrates a result of calculating the illuminance distribution of the stray light on the virtual image plane in the case where the step-surface angle θd(L1) of the first Fresnel lens surface Fr1 and the step-surface angle θd(L2) of the second Fresnel lens surface Fr2 are varied. Referring to FIG. 17, regarding the eyepiece according to the second configuration example (Example 2), setting each of the step-surface angles θd(L1) and θd(L2) to an angle of 20° or greater makes it possible to reduce the dominant stray light, making it possible to provide a high-contrast visual image.

It is preferable that other configurations be approximately similar to those in the eyepiece according to the first configuration example described above.

### Third Configuration Example

An eyepiece according to a third configuration example of the present disclosure corresponds to a configuration (FIG. 55) of an eyepiece according to Example 3 described later.

As with the eyepiece according to the first configuration example described above, the eyepiece according to the third configuration example of the present disclosure has a two-group two-lens configuration in which the first lens L1 and the second lens L2 are disposed in order from the eye point E.P. side toward the image side.

In a manner approximately similar to that of the eyepiece according to the first configuration example, the eyepiece according to the third configuration example of the present disclosure includes the first Fresnel lens surface Fr1 and the second Fresnel lens surface Fr2 that are opposed to each other in the first lens L1 and the second lens L2.

Note that, in the eyepiece according to the third configuration example of the present disclosure, the first Fresnel lens surface Fr1 and the second Fresnel lens surface Fr2 are formed only in a peripheral region.

In the eyepiece according to the third configuration example of the present disclosure, the first Fresnel lens surface Fr1 is formed only in the peripheral region on the lens surface (the L1(R2) surface), of the first lens L1, that is opposed to the second lens L2. A middle region of the L1 (R2) surface of the first lens L1 is provided as a first non-Fresnel lens surface (a spherical surface or an aspherical surface).

Similarly, in the eyepiece according to the third configuration example of the present disclosure, the second Fresnel lens surface Fr2 is formed only in the peripheral region on the lens surface (the L2(R1) surface), of the second lens L2, that is opposed to the first lens L1. A middle region of the L2(R1) surface of the second lens L2 is provided as a second non-Fresnel lens surface (a spherical surface or an aspherical surface).

Typically, the Fresnel lens has poor sharpness due to an influence of the step surface 302 or a manufacturing error, compared with the standard lens. In the eyepiece according to the third configuration example of the present disclosure, however, owing to the use of the standard lens in the middle region, it is possible to secure high definition in the central region of the image. Border parts of the optical system of the middle region and the peripheral region are smoothly coupled to each other, making it possible to prevent the borders from being visually recognized.

In the eyepiece (FIG. 55) according to Example 3 described later, an effective diameter φᵥ₁ of the middle region of the L1(R2) surface of the first lens L1 is 25.004, and an effective diameter φᵥ₂ of the middle region of the L2(R1) surface of the second lens L2 is 27.054. The effective diameters φᵥ₁ and φᵥ₂ of the middle regions are each an effective range that allows a bundle of light rays entering a pupil at an angle of 35° to pass therethrough in a state where the pupil center is on the optical axis. Thus providing the border part between the Fresnel lens surface and the standard lens surface at about 35° or greater in the field of view makes it more difficult for the border between the middle region and the peripheral region to be recognized, achieving a natural appearance. If it is much less than 35°, the border part becomes conspicuous, leading to a concern of deterioration of image quality.

It is preferable that other configurations be approximately similar to those in the eyepiece according to the first configuration example described above. [Fourth Configuration Example]

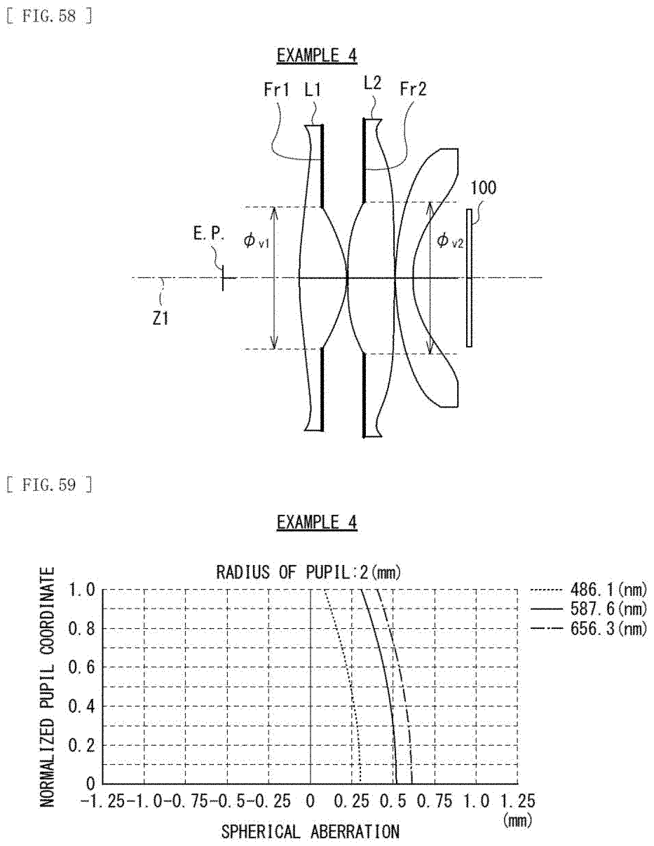

An eyepiece according to a fourth configuration example of the present disclosure corresponds to a configuration (FIG. 58) of an eyepiece according to Example 4 described later.

Compared with the eyepiece according to the third configuration example described above, the eyepiece according to the fourth configuration example of the present disclosure has a configuration that further includes a third lens L3 disposed closer to the image side than the first lens L1 and the second lens L2. That is, the eyepiece according to the fourth configuration example of the present disclosure has a three-group three-lens configuration in which the first lens L1, the second lens L2, and the third lens L3 are disposed in order from the eye point E.P. side toward the image side.

The third lens L3 is a standard lens in which no Fresnel lens surface is used. It is preferable that the third lens L3 be an aspherical lens on which an aspherical surface having an inflection point is formed on at least one surface.

Compared with the eyepiece according to the third configuration example, the eyepiece according to the fourth configuration example of the present disclosure is increased in weight, total length of the optical system, etc. by the addition of the third lens L3; however, more adequate aberration correction is allowed, making it possible to provide a high-definition image, as described later in Example 4.

In a manner approximately similar to that of the eyepiece according to the first configuration example, the eyepiece according to the fourth configuration example of the present disclosure includes the first Fresnel lens surface Fr1 and the second Fresnel lens surface Fr2 that are opposed to each other in the first lens L1 and the second lens L2.

Note that, in the eyepiece according to the fourth configuration example of the present disclosure, the first Fresnel lens surface Fr1 and the second Fresnel lens surface Fr2 are formed only in a peripheral region, as with the eyepiece according to the third configuration example.

In the eyepiece (FIG. 58) according to Example 4 described later, an effective diameter φᵥ₁ of the middle region of the L1(R2) surface of the first lens L1 is 24.116, and an effective diameter φᵥ₂ of the middle region of the L2(R1) surface of the second lens L2 is 27.038. The effective diameters φᵥ₁ and φᵥ₂ of the middle region are each an effective range that allows a bundle of light rays entering a pupil at an angle of 35° to pass therethrough in a state where the pupil center is on the optical axis, as with the eyepiece according to Example 3.

It is preferable that other configurations be approximately similar to those in the eyepiece according to the third configuration example described above.

### (Overview of Visibility State of Annular Section)

Next, a description is given of the fifth to the eighth configuration examples in which a visibility state of the annular section 301 is improved, compared with that in the first to the fourth configuration examples described above. First, an overview of the visibility state of the annular section 301 is described.

As described above, in the first to the fourth configuration examples, appropriately setting the step-surface angle θd(L1) of the first Fresnel lens surface Fr1 and the step-surface angle θd(L2) of the second Fresnel lens surface Fr2 allows for reduction in generation of stray light due to the step surface 302.

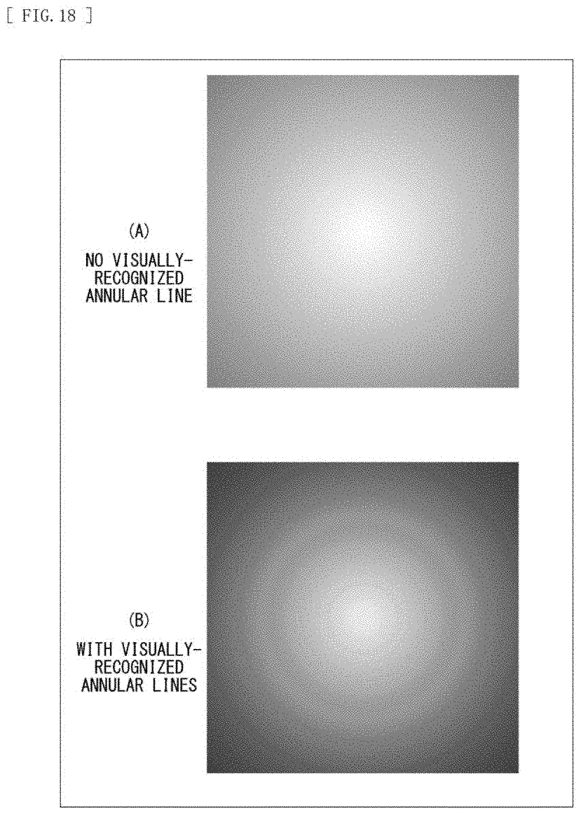

In contrast, as illustrated in (B) of FIG. 18, an optical system using a typical Fresnel lens has an issue that concentric lines (referred to as “annular lines”) derived from the annular sections 301 are visually recognized in the virtual image plane. Note that (A) of FIG. 18 illustrates an example of a state in which no annular line is visually recognized.

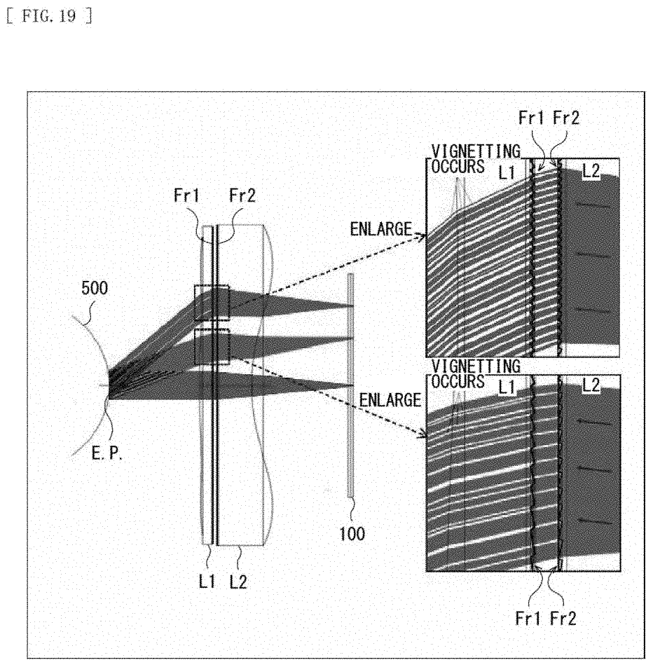

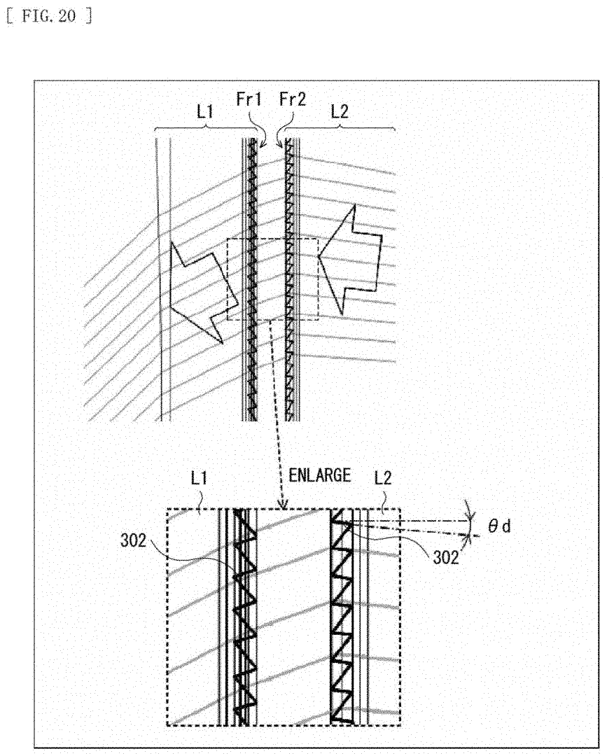

FIG. 19 illustrates an overview of a principle of generation of the annular lines. FIG. 20 illustrates an example of a method of improving the visibility state of typical annular lines. FIGS. 19 and 20 each illustrate an example of the two-group two-lens configuration in which the first lens L1 and the second lens L2 are disposed, and the lens surfaces opposed to each other are the first Fresnel lens surface Fr1 and the second Fresnel lens surface Fr2, as in the eyepiece according to the first configuration example described above.

As illustrated in FIG. 19, the vignetting of the light resulting from the step surfaces 302 of the first Fresnel lens surface Fr1 and the second Fresnel lens surface Fr2 causes a generation amount of the vignetting to vary in accordance with the angle of view. As a result, the annular lines are visually recognized in the virtual image plane. As a means for solving this, as illustrated in FIG. 20, there is a method of causing an angle of a light ray entering the first Fresnel lens surface Fr1 and the second Fresnel lens surface Fr2 to coincide with the step-surface angle θd. According to this method, the annular lines can be improved; however, because it is necessary to set the step-surface angle θd to be smaller than the predetermined angle (e.g., 15° or 20°) described above in the first to the fourth configuration examples, stray light is generated, thereby lowering contrast. Therefore, it is difficult to achieve both reduction of the stray light and reduction of visibility of the annular lines in the first to the fourth configuration examples described above.

Therefore, a description is given of configuration examples of an eyepiece that makes it possible to further improve the visibility state of the annular lines and to provide a visual image with higher image quality, compared with the first to the fourth configuration examples. According to the fifth to the eighth configuration examples described below, image quality in a central region of the field of view is improved in particular.

### (Overview of Fifth to Eighth Configuration Examples]

The fifth to the eighth configuration examples are different in the step-surface angle θd from the first to the fourth configuration examples described above, but have basic configurations similar to those of the first to the fourth configuration examples described above. Each of the fifth to the eighth configuration examples includes at least the first lens L1 and the second lens L2, and the lens surfaces opposed to each other are provided as the first Fresnel lens surface Fr1 and the second Fresnel lens surface Fr2. It is preferable that each of eyepieces according to the fifth to the eighth configuration examples satisfy the foregoing conditional expression (1) to have the image magnification My of 2.1 or greater, and be applied to the eyepiece optical system 102 in which the size of the image display device 100 is smaller than the lens diameter of the eyepiece 101 as in the configuration example illustrated in FIG. 1.

### (Conditions for Simulation)

Calculation for simulations in the fifth to the eighth configuration examples was made under the following conditions unless otherwise specified.
A light distribution characteristic of the image display device 100: Lambertian
The size of the image display device 100: 17 mm×27 mm (vertical×horizontal)
A pupil diameter: φ 4 mm
A shape of the Fresnel lens surface: An annular-section height Rh=150 μm (constant) (An annular-section pitch Rp is unequal)
A reference wavelength: 587.6 nm (d-line)

### Fifth Configuration Example

The eyepiece according to the fifth configuration example of the present disclosure corresponds to a configuration (FIG. 61) of an eyepiece according to Example 5 described later.

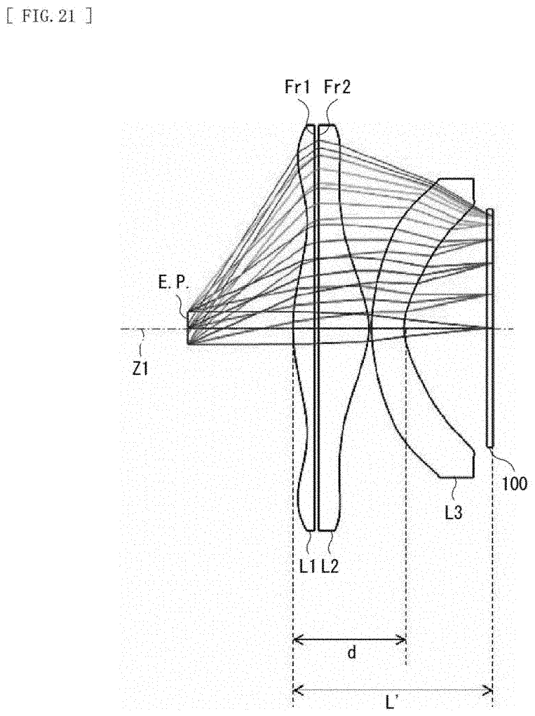

FIG. 21 illustrates the fifth configuration example of the eyepiece according to the embodiment. As illustrated in FIG. 21, compared with the configuration of the eyepiece according to the first configuration example described above, the eyepiece according to the fifth configuration example has a configuration that further includes a third lens L3 disposed closer to the image side than the first lens L1 and the second lens L2. That is, the eyepiece according to the fifth configuration example has a three-group three-lens configuration in which the first lens L1, the second lens L2, and the third lens L3 are disposed in order from the eye point E.P. side toward the image side.

The first Fresnel lens surface Fr1 is formed in an entire region from a center to a periphery of a lens surface (a L1(R2) surface), of the first lens L1, that is opposed to the second lens L2.

The second Fresnel lens surface Fr2 is formed in an entire region from a center to a periphery of a lens surface (a L2(R1) surface), of the second lens L2, that is opposed to the first lens L1.

The third lens L3 is a standard lens in which no Fresnel lens surface is used. It is preferable that the third lens L3 be an aspherical lens.

As illustrated in FIG. 21, it is desirable that the eyepiece according to the fifth configuration example satisfy

0.2<d/L′<0.6 (4)

where L′ is a distance from a most-eye-point-side lens surface to the image plane, and d is a distance from the most-eye-point-side lens surface to a most-image-side lens surface.

A conditional expression (4) relates to an appropriate range of a ratio between the distance (L′) obtained by subtracting the eye relief E.R. from the total length of the eyepiece and the distance d from the most-eye-point-side lens surface to the most-image-side lens surface. Satisfying the conditional expression (4) makes it possible to perform balanced aberration correction with a short total length.

### (Relationship Between Positions of Fresnel Lens Surfaces and Visibility State of Annular Lines)

FIG. 22 illustrates an example of the visibility state of the annular lines in the eyepiece according to the fifth configuration example. FIG. 23 illustrates a configuration example of the eyepiece according to a comparative example for the eyepiece according to the fifth configuration example.

Light from the image display device 100 involves vignetting occurring due to the step surfaces 302 of the first Fresnel lens surface Fr1 and the second Fresnel lens surface Fr2. Accordingly, an in-plane luminance distribution in the vicinity of the first Fresnel lens surface Fr1 and the second Fresnel lens surface Fr2 has a great light-dark contrast as illustrated in (A) in FIG. 22. The eyepiece according to the fifth configuration example is characterized in that the first Fresnel lens surface Fr1 and the second Fresnel lens surface Fr2 are disposed on the side closer (for example, at about 15 mm) to the eye 500. A focal position of a human eye is at a position away from the first Fresnel lens surface Fr1 and the second Fresnel lens surface Fr2, for example, at a position 100 mm or more away from the eye 500. Because the human eye cannot focus on the position of the first Fresnel lens surface Fr1 and the second Fresnel lens surface Fr2, it is defocused as illustrated in (B) of FIG. 22 and visually recognized as the annular lines.

As described above, in the eyepiece according to the fifth configuration example, the first Fresnel lens surface Fr1 and the second Fresnel lens surface Fr2 are disposed on the side closer to the eye 500, allowing for an increase in a blurring amount of the annular lines and making it possible to lower the visibility of the annular lines. In contrast, in the eyepiece according to the comparative example in FIG. 23, the second Fresnel lens surface Fr2 is disposed on the image-side lens surface of the second lens L2. In the eyepiece according to the comparative example in FIG. 23, the second Fresnel lens surface Fr2 is disposed at a position further away from the eye 500, compared with the eyepiece according to the fifth configuration example, making it easier for the annular lines to be visually recognized than in the eyepiece according to the fifth configuration example.

### (Relationship Between Positions of Annular Sections on Fresnel Lens Surfaces and Visibility State of Annular Lines)

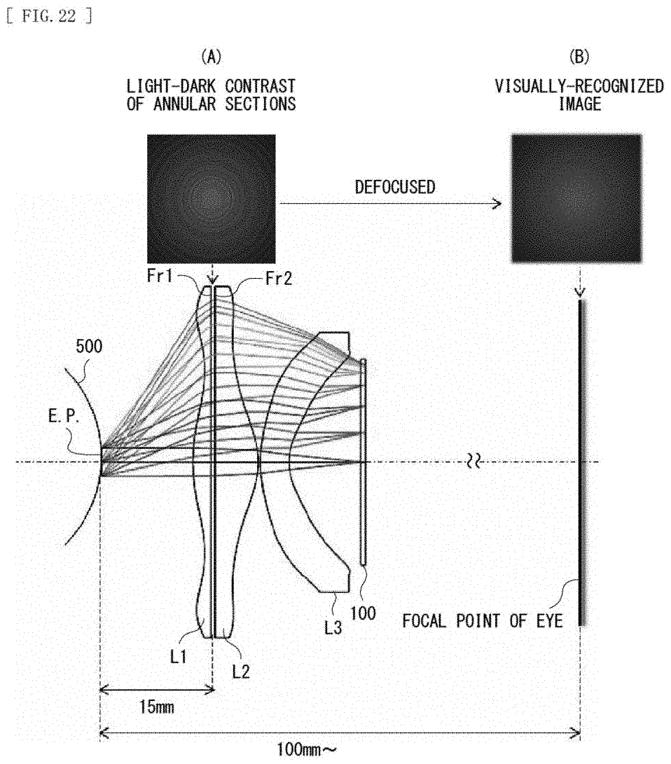

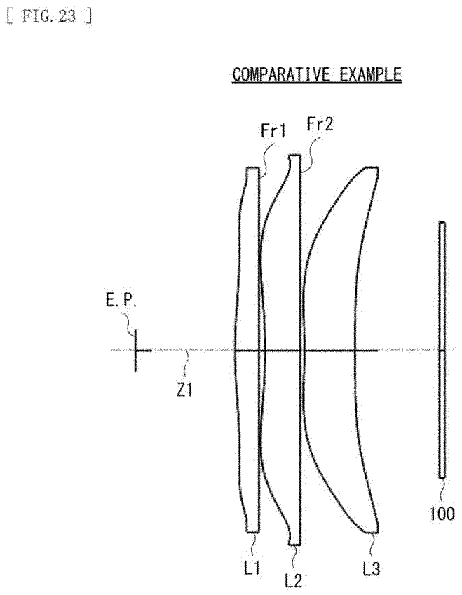

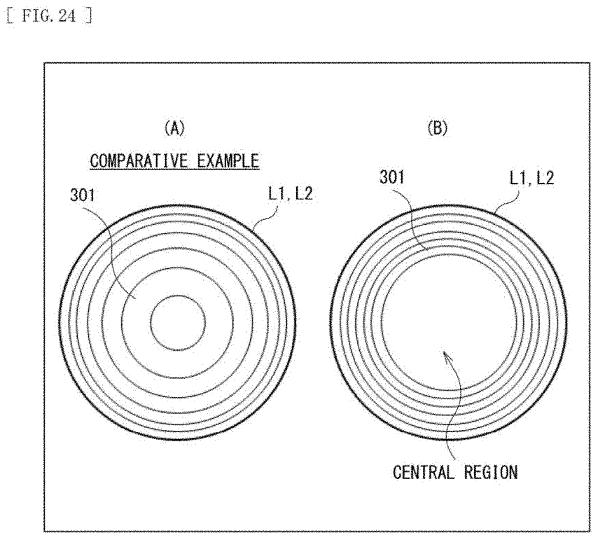

FIG. 24 illustrates a configuration example of the annular sections 301 of the first Fresnel lens surface Fr1 and the second Fresnel lens surface Fr2 in the eyepiece according to the fifth configuration example, together with those according to the comparative example.

It is desirable that an eyepiece optical system such as a head-mounted display secure sufficient definition particularly in the central region of the field of view. As illustrated in the comparative example in (A) of FIG. 24, in a case where the annular sections 301 of the first Fresnel lens surface Fr1 and the second Fresnel lens surface Fr2 are in the central region, the definition is lowered due to the annular sections 301, making it easier for the annular lines to be visually recognized. Therefore, as illustrated in (B) of FIG. 24, it is desirable to provide the first annular section (the first annular section) counted from the center in a region as peripheral as possible in the first Fresnel lens surface Fr1 and the second Fresnel lens surface Fr2.

As illustrated in FIGS. 8 and 9 described above, the two or more annular sections 301 in the first Fresnel lens surface Fr1 and the second Fresnel lens surface Fr2 are formed by, for example, concentrically dividing the convex lens 400. The convex lens 400 to be a base for forming the annular sections 301 has, for example, an aspherical shape. In order to provide the first annular section in the peripheral region, it is desirable that the aspherical shape of the base have refractive power, in a central region, which is suppressed to be small.

Therefore, it is desirable to satisfy

(ψ1+ψ2)/ψall<0.30 (5)

where ψ1 is the refractive power of the first Fresnel lens surface Fr1, ψ2 is the refractive power of the second Fresnel lens surface Fr2, and ψall is the total refractive power of the eyepiece.

A conditional expression (5) expresses a ratio of the refractive power of the first Fresnel lens surface Fr1 and the second Fresnel lens surface Fr2 relative to the total refractive power ψall of the eyepiece. A small value of the conditional expression (5) means that on-axial refractive power of the first Fresnel lens surface Fr1 and the second Fresnel lens surface Fr2 is small.

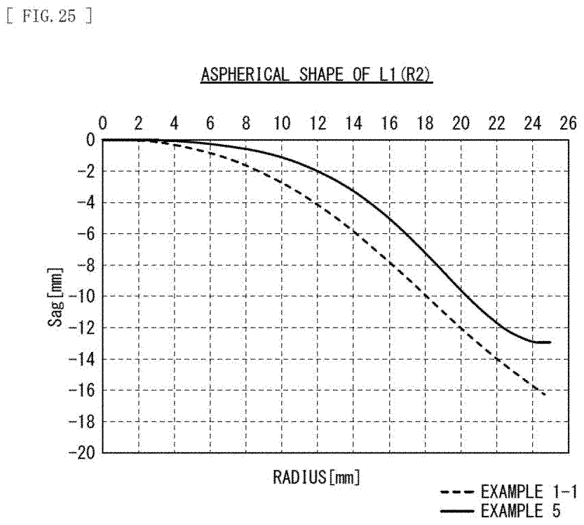

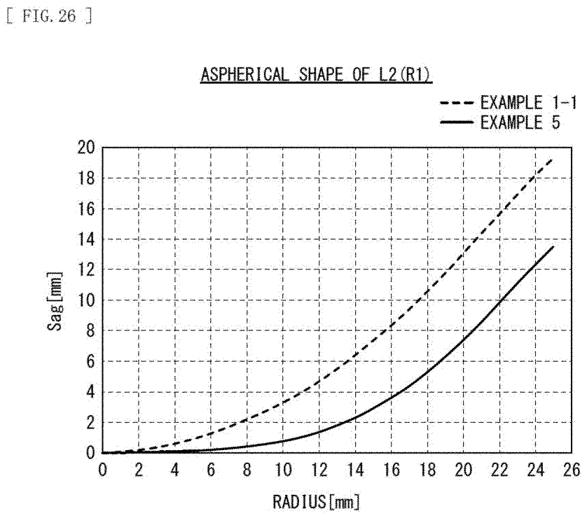

FIG. 25 illustrates an example of a sag amount of the aspherical shape to be the base for forming the first Fresnel lens surface Fr1 in the eyepiece according to the fifth configuration example, together with that according to the comparative example. FIG. 26 illustrates an example of a sag amount of the aspherical shape to be the base for forming the second Fresnel lens surface Fr2 in the eyepiece according to the fifth configuration example, together with that of the comparative example.

The sag amounts illustrated in FIGS. 25 and 26 represent data using that of the eyepiece according to Example 5 described later. Further, FIGS. 25 and 26, each illustrate, as a comparative example, a sag amount using the data of the eyepiece according to Example 1-1 described later corresponding to the first configuration example. In the eyepiece according to Example 5, the aspherical shape to be the base has a sag amount, in the central region, that is suppressed to be relatively small, compared with that of the eyepiece according to Example 1-1. In a case where the annular sections 301 are formed with the aspherical shape, as the base, that has the sag amount suppressed to be small as described above, a distance from the lens center to the first annular section is allowed to be shifted to the periphery of the field of view. For example, in a case where the annular sections 301 are formed with the annular-section height Rh of 150 μm, the distance from the lens center to the first annular section is as follows in each of Examples 1-1 and 5.

### Example 1-1

A distance to the first annular section of the first Fresnel lens surface Fr1: 2.5 mm

A distance to the first annular section of the second Fresnel lens surface Fr2: 2.1 mm

### Example 5

A distance to the first annular section of the first Fresnel lens surface Fr1: 4.1 mm

A distance to the first annular section of the second Fresnel lens surface Fr2: 6.6 mm

With the above-described configurations of the annular sections 301, the visibility of the annular lines of the eyepiece according to Example 1-1 and the visibility of the annular lines of the eyepiece according to Example 5 were simulated and were compared with each other. As a result, it was confirmed that, regarding the eyepiece according to Example 5, there was no annular line in the central region of the field of view, and favorable image quality was obtained.

Note that, it is also possible to shift the position of the first annular section to the periphery by increasing only the annular-section height Rh of the first annular section. However, this increases the on-axial thickness of the Fresnel lens. It is therefore more desirable to suppress the sag amount in the central region, as described above.

### (Relationship Between Annular Sections of Two Fresnel Lens Surfaces)

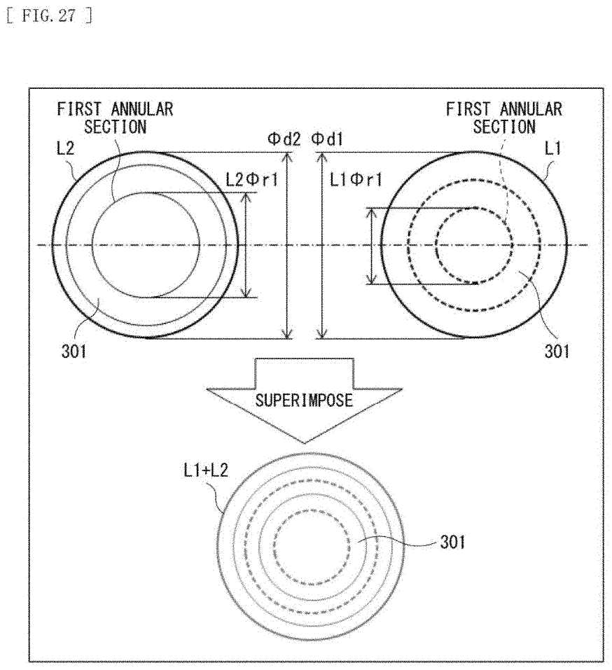

FIG. 27 illustrates a desirable configuration example of the annular sections 301 of the first Fresnel lens surface Fr1 and the second Fresnel lens surface Fr2 in the eyepiece according to the fifth configuration example.

As described with reference to FIG. 22, the light-dark contrast of luminance is defocused in the vicinity of the Fresnel lens surface, which causes a low-frequency component to be visually recognized as the annular lines. Therefore, causing a generation period of the light and the dark in the vicinity of the Fresnel lens surface to have a high frequency makes it possible to lower the visibility of the annular lines.

To achieve this, as illustrated in FIG. 27, it is desirable that a pitch of the annular sections 301 in the first Fresnel lens surface Fr1 and a pitch of the annular sections 301 in the second Fresnel lens surface Fr2 be shifted from each other by a half period. Regarding the eyepiece according to the fifth configuration example, the visibility of the annular lines in a case of shifted pitches and that in a case of non-shifted pitches were simulated and were compared with each other. As a result, it was confirmed that the visibility of the annular lines was lowered in the case of the shifted pitches.

In view of the above, it is desirable that the eyepiece according to Example 5 satisfy, regarding the configuration of the annular sections 301,

0.1≤L1Φr1/Φd1 (6) and

0.2≤L2Φr1/Φd2 (7)

where, as illustrated in FIG. 27, L1Φr1 is a diameter of the first annular section 301 counted from the center of the first Fresnel lens surface Fr1, Φd1 is the effective diameter of the first Fresnel lens surface Fr1, L2Φr1 is a diameter of the first annular section 301 counted from the center of the second Fresnel lens surface Fr2, and Φd2 is the effective diameter of the second Fresnel lens surface Fr2.

A conditional expression (6) relates to a ratio between the diameter (L1ψr1) of the first annular section and the effective diameter (Φd1) of the first Fresnel lens surface Fr1. Satisfying the conditional expression (6) makes it possible to secure high definition at the center of the field of view.

A conditional expression (7) relates to a ratio between the diameter (L2Φr1) of the first annular section and the effective diameter (Φd2) of the second Fresnel lens surface Fr2. Satisfying the conditional expression (7) makes it possible to secure high definition at the center of the field of view.

It is preferable that other configurations be approximately similar to those in the eyepiece according to the first or the second configuration example described above.

### Sixth Configuration Example

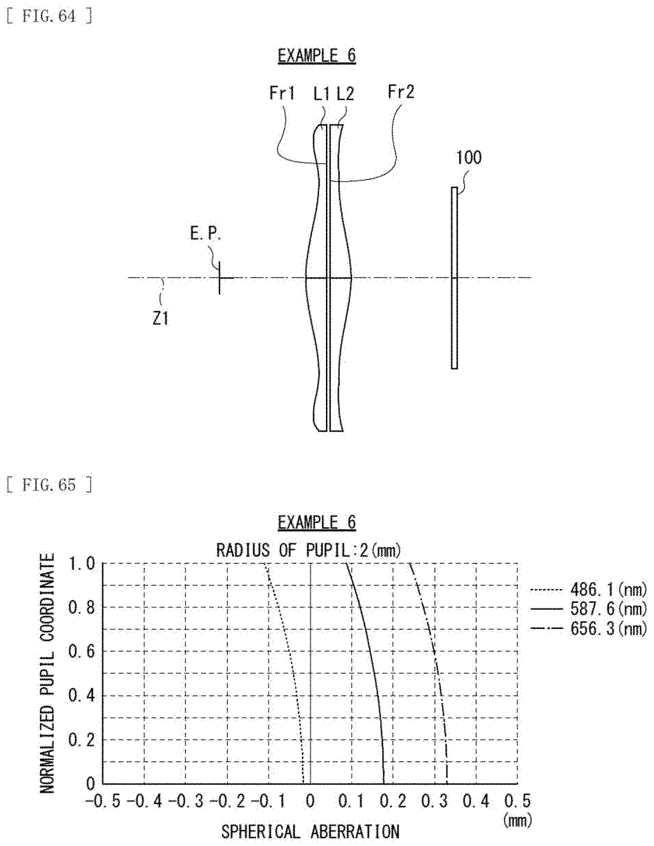

The eyepiece according to the sixth configuration example of the present disclosure corresponds to a configuration (FIG. 64) of an eyepiece according to Example 6 described later.

Compared with the configuration of the eyepiece according to the fifth configuration example described above, the eyepiece according to the sixth configuration example has a configuration without the third lens L3. That is, the eyepiece according to the sixth configuration example has a two-group two-lens configuration in which the first lens L1 and the second lens L2 are disposed in order from the eye point E.P. side toward the image side.

The first Fresnel lens surface Fr1 is formed in an entire region from a center to a periphery of a lens surface (a L1 (R2) surface), of the first lens L1, that is opposed to the second lens L2.

The second Fresnel lens surface Fr2 is formed in an entire region from a center to a periphery of a lens surface (a L2(R1) surface), of the second lens L2, that is opposed to the first lens L1.

Compared with the configuration of the eyepiece according to the fifth configuration example described above, the eyepiece according to the sixth configuration example has one lens omitted, thereby allowing for expectation of reduction in total length and weight. Note that the overall configuration of the annular sections 301 of the first Fresnel lens surface Fr1 and the second Fresnel lens surface Fr2, the position of the first annular section, etc. of the eyepiece according to the sixth configuration example are designed on the basis of a concept similar to that of the eyepiece according to the fifth configuration example. The visibility of the annular lines of the eyepiece according to the sixth configuration example was simulated. As a result, it was confirmed that the visibility of the annular lines was improved compared with that of the eyepiece according to the first configuration example.

It is preferable that other configurations be approximately similar to those in the eyepiece according to the fifth configuration example described above.

### Seventh Configuration Example

The eyepiece according to the seventh configuration example of the present disclosure corresponds to a configuration (FIG. 67) of an eyepiece according to Example 7 described later.

As with the eyepiece according to the fifth configuration example described above, the eyepiece according to the seventh configuration example of the present disclosure has a three-group three-lens configuration in which the first lens L1, the second lens L2, and the third lens L3 are disposed in order from the eye point E.P. side toward the image side.

The first Fresnel lens surface Fr1 is formed in an entire region from a center to a periphery of a lens surface (a L1 (R2) surface), of the first lens L1, that is opposed to the second lens L2.

The second Fresnel lens surface Fr2 is formed in an entire region from a center to a periphery of a lens surface (a L2(R1) surface), of the second lens L2, that is opposed to the first lens L1.

The third lens L3 is a standard lens in which no Fresnel lens surface is used. It is preferable that the third lens L3 be an aspherical lens.

The overall configuration of the annular sections 301 of the first Fresnel lens surface Fr1 and the second Fresnel lens surface Fr2, the position of the first annular section, etc. of the eyepiece according to the seventh configuration example are designed basically on the basis of a concept similar to that of the eyepiece according to the fifth configuration example described above. However, the eyepiece according to the seventh configuration example is characterized in that the first Fresnel lens surface Fr1 and the second Fresnel lens surface Fr2 that are opposed to each other have the effective surfaces of the same shape. That is, as described later in Tables 38 and 40 regarding Example 7, a curvature radius, an absolute value of an aspherical coefficient, etc. are designed to have the same values between the first Fresnel lens surface Fr1 and the second Fresnel lens surface Fr2.

Thus providing the effective surfaces of the first Fresnel lens surface Fr1 and the second Fresnel lens surface Fr2 with the same shape makes it easier to shift the pitch of the annular sections 301 in the first Fresnel lens surface Fr1 and the pitch of the annular sections 301 in the second Fresnel lens surface Fr2 from each other by a half period, for example, as illustrated in FIG. 27 described above. Further, because the two Fresnel lens surfaces have the same shape, the two Fresnel lens surfaces result in approximately the same light-dark contrast. It is therefore possible to more favorably improve the visibility of the annular lines in the eyepiece according to the seventh configuration example.

It is preferable that other configurations be approximately similar to those in the eyepiece according to the fifth configuration example described above.

### Eighth Configuration Example

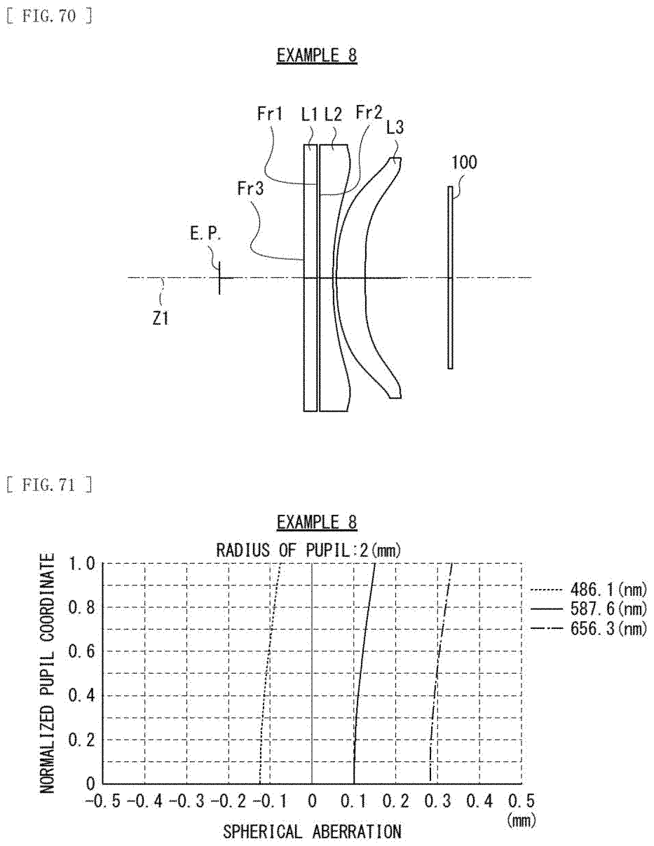

The eyepiece according to the eighth configuration example of the present disclosure corresponds to a configuration (FIG. 70) of an eyepiece according to Example 8 described later.

As with the eyepiece according to the fifth configuration example described above, the eyepiece according to the eighth configuration example of the present disclosure has a three-group three-lens configuration in which the first lens L1, the second lens L2, and the third lens L3 are disposed in order from the eye point E.P. side toward the image side.

As with the eyepiece according to the fifth configuration example, the eyepiece according to the eighth configuration example includes the first Fresnel lens surface Fr1 and the second Fresnel lens surface Fr2 that are formed on the respective surfaces of the first lens L1 and the second lens L2 that are opposed to each other. Further, in the eyepiece according to the eighth configuration example, the lens surface (L1(R1) surface), of the first lens L1, on the eye point E.P. side is provided as a third Fresnel lens surface Fr3. This is a point that differs from the configuration of the eyepiece according to the fifth configuration example.

The eyepiece according to the eighth configuration example uses three Fresnel lens surfaces, thereby allowing for sufficient aberration correction and making it possible to further increase the definition, as compared with the eyepiece according to the fifth configuration example. Moreover, because the number of the annular sections 301 is increased, the frequency of the annular lines is allowed to be higher by designing the overall configuration of the annular sections 301, the position of the first annular section, etc. for the three Fresnel lens surfaces on the basis of a concept similar to that of the eyepiece according to the fifth configuration example described above. This makes it possible to further lower the visibility of the annular lines. The visibility of the annular lines of the eyepiece according to the eighth configuration example was simulated. As a result, it was confirmed that the visibility of the annular lines was further improved, as compared with the eyepiece according to the fifth configuration example.

It is preferable that other configurations be approximately similar to those in the eyepiece according to the fifth configuration example described above.

### Effects of Invention

According to the eyepiece of the embodiment of the present disclosure, the configuration of the first lens L1 and the second lens L2 that are opposed to each other is optimized with use of the Fresnel lens. It is therefore possible to achieve a wide viewing angle and favorable aberration correction while reducing a weight and a total length.

Applying the eyepiece according to the embodiment to a head-mounted display makes it possible to provide a beautiful image at high-definition with a great viewing angle. According to the eyepiece of the embodiment, it is possible to reduce the total length (the distance L from the eye point E.P. to the image). Moreover, it is possible to suppress the size of the optical system in a case of being applied to the eyepiece optical system 102 to be small.

Note that the effects described herein are merely illustrative and not limitative, and any other effect may be provided.

### 3. Example of Application to Display Apparatus

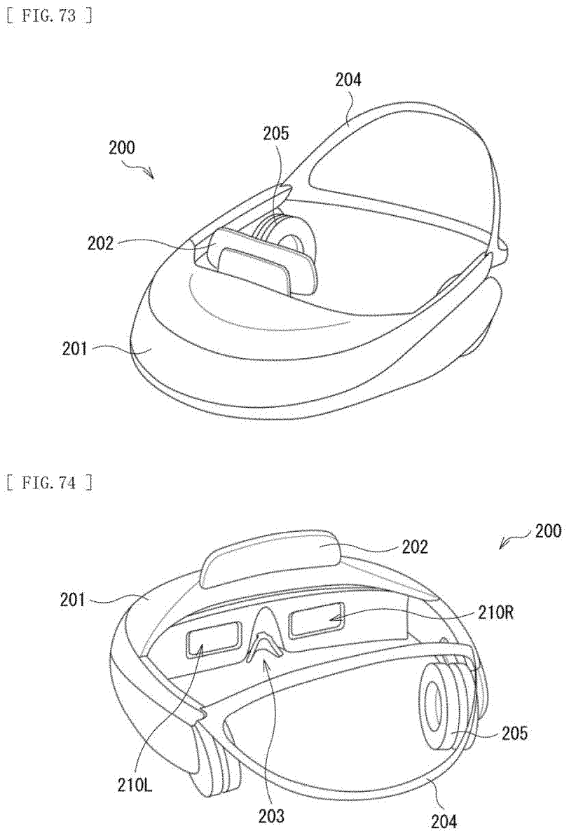

FIGS. 73 and 74 each illustrate a configuration example of a head-mounted display 200 as an example of a display apparatus to which the eyepiece according to the embodiment of the present disclosure is applied. The head-mounted display 200 includes a body 201, a forehead rest 202, a nose rest 203, a headband 204, and headphones 205. The forehead rest 202 is provided at an upper-middle part of the body 201. The nose rest 203 is provided at a lower-middle part of the body 201.

When a user wears the head-mounted display 200 on his/her head, the forehead rest 202 comes into contact with the forehead of the user and the nose rest 203 comes into contact with his/her nose. In addition, the headband 204 comes into contact with the back of his/her head. As a result, the head-mounted display 200 distributes a load of the apparatus over the entire head. This makes it possible for the user to wear the head-mounted display 200 with a less burden on the user.

The headphones 205 are provided for the left ear and the right ear. This makes it possible to independently provide sounds to the left ear and the right ear.

The body 201 is provided with a circuit board, an optical system, etc. that are built in the body 201 and are adapted to display an image. As illustrated in FIG. 74, a left-eye display unit 210L and a right-eye display unit 210R are provided in the body 201. This makes it possible to provide images to the left eye and the right eye independently. The left-eye display unit 210L is provided with the image display device 100 for the left eye and an eyepiece optical system for the left eye that magnifies an image displayed on the image display device 100 for the left eye. The right-eye display unit 210R is provided with the image display device 100 for the right eye and an eyepiece optical system for the right eye that magnifies an image displayed on the image display device 100 for the right eye. The eyepiece according to the embodiment of the present disclosure is applicable as each of the eyepiece optical system for the left eye and the eyepiece optical system for the right eye.

Note that the image display device 100 receives image data from an unillustrated image reproducing apparatus. It is also possible to perform three-dimensional display by supplying three-dimensional image data from the image reproducing apparatus and displaying images having parallaxes with respect to each other by means of the left-eye display unit 210L and the right-eye display unit 210R.

Note that, although an example in which the display apparatus is applied to the head-mounted display 200 has been described here, an application range of the display apparatus is not limited to the head-mounted display 200. For example, the display apparatus may be applied to electronic binoculars, an electronic viewfinder of a camera, etc.

Moreover, the eyepiece according to the embodiment of the present disclosure is applicable not only to the use of magnifying an image displayed on the image display device 100, but also to an observation apparatus that magnifies an optical image formed by an objective lens.

### EXAMPLES

### Overview of Examples

The eyepieces according to the following Examples 1-1 to 1-8 correspond to the eyepiece (FIG. 5) of the first configuration example described above. Example 2 corresponds to the eyepiece of the second configuration example described above. Example 3 corresponds to the eyepiece of the third configuration example described above. Example 4 corresponds to the eyepiece of the fourth configuration example described above. Example 5 corresponds to the eyepiece of the fifth configuration example described above. Example 6 corresponds to the eyepiece of the sixth configuration example described above. Example 7 corresponds to the eyepiece of the seventh configuration example described above. Example 8 corresponds to the eyepiece of the eighth configuration example described above.

### 4. Numerical Examples of Lenses

Note that meanings, etc. of symbols used in the following tables and descriptions are as follows. “Si” indicates the number of the i-th surface, which is numbered to sequentially increase toward the image side, with the eye point E.P. is numbered as the first. “Ri” indicates a paraxial curvature radius (mm) of the i-th surface. “Di” indicates a spacing (mm), on an optical axis, from the i-th surface to the (i+1)-th surface. “Ndi” indicates a value of a refractive index at the d-line (a wavelength of 587.6 nm) of a material (a medium) of an optical element having the i-th surface. “vdi” indicates a value of Abbe's number at the d-line of the material of the optical element having the i-th surface. A surface having a curvature radius of “Go” indicates a planar surface or a stop surface (an aperture stop STO). Further, in “COMMENT”, the type of the lens surface, etc. are described.

The eyepiece according to each of Examples includes an aspherical surface. The aspherical shape is defined by the following expression of aspherical surface. Note that, in each of the following tables describing aspherical coefficients, “E-n” represents an exponential expression with a base of 10, that is, “minus n-th power of 10”. For example, “0.12345E-05” represents “0.12345×(minus fifth-power of 10)”.

Z=(Y²/R)/[1+{1−(1+K)(Y²/R²)}^{1/2}]+ΣAi·Yi (Expression of Aspherical Surface)

### Where

Z is a depth of an aspherical surface,

Y is a height from an optical axis,

R is a paraxial curvature radius,

K is a conic constant, and

Ai is an aspherical coefficient of i-th order (i is an integer of 3 or greater).

### (Regarding Data of Fresnel Lens Surface)

Moreover, the eyepiece according to each of Examples includes a Fresnel lens surface. In each of the following Examples, a shape of the Fresnel lens surface is expressed equivalently by the expression of aspherical surface described above. In each of the following Examples, an ideal Fresnel lens surface with the step surface 302 of the Fresnel lens surface having an infinitesimal height.

### Example 1-1

Table 1 describes basic lens data of the eyepiece according to Example 1-1. Further, Table 2 and Table 3 describe aspherical surface data. Table 2 describes the aspherical surface data of standard lens surfaces. Table 3 describes the aspherical surface data of Fresnel lens surfaces.

TABLE 1
Example 1-1 Lens Data

| Si | | Ri | | Ndi | νdi |
|---|---|---|---|---|---|
| Surface | | Curvature | Di | Refractive | Abbe's |
| number | COMMENT | radius | Spacing | index | number |
| 1 | E.P. (Stop) | ∞ | 13.000 | — | — |
| 2 | Standard | 236.654 | 1.980 | 1.535 | 55.710 |
| | lens surface | | | | |
| 3 | Fresnel | −20.916 | 0.500 | — | — |
| | lens surface | | | | |
| 4 | Fresnel | 14.490 | 5.000 | 1.535 | 55.710 |
| | lens surface | | | | |
| 5 | Standard | 33.222 | 13.931 | — | — |
| | lens surface | | | | |
| 6 | Cover glass | ∞ | 0.700 | 1.517 | 64.167 |
| 7 | Image plane | ∞ | — | — | — |

TABLE 2
Example 1-1 Aspherical Surface Data of Standard Lens Surfaces

| Si | K | 3rd order | 4th order | 5th order |
|---|---|---|---|---|
| 2 | −2.178 | 6.694E−04 | −6.696E−05 | −4.453E−07 |
| 5 | −32.654 | 8.889E−04 | 1.679E−05 | −6.362E−06 |
| Si | 6th order | 7th order | 8th order | 9th order |
| 2 | 9.010E−08 | 7.922E−10 | 1.027E−10 | −1.403E−12 |
| 5 | 2.277E−07 | −3.133E−09 | −2.738E−10 | 2.341E−11 |

TABLE 3
Example 1-1 Aspherical Surface Data of Fresnel Lens Surfaces

| Si | K | 4th order | 6th order | 8th order |
|---|---|---|---|---|
| 3 | −0.814 | −4.89E−05 | 1.17E−07 | −6.37E−11 |
| 4 | −3.772 | 4.98E−05 | −4.43E−08 | — |
| Si | 10th order | 12th order | 14th order | 16th order |
| 3 | — | — | — | — |
| 4 | — | — | — | — |

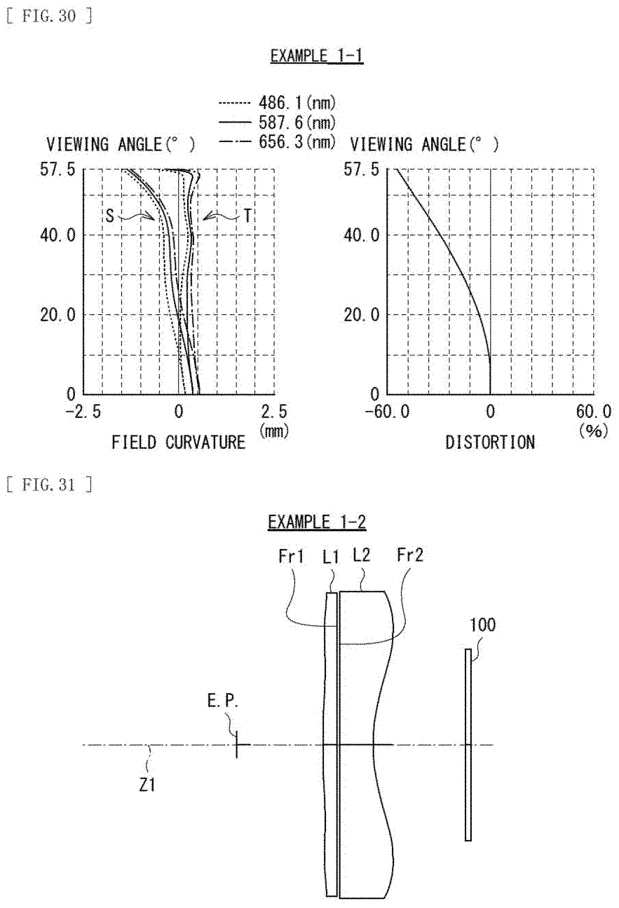

FIG. 28 illustrates a lens cross-section of the eyepiece according to Example 1-1. FIGS. 29 and 30 illustrate various aberrations of the eyepiece according to Example 1-1. Each aberration is obtained by tracing a light ray from the eye point E.P. side. In particular, FIG. 29 illustrates spherical aberration. FIG. 30 illustrates astigmatism (field curvature) and distortion. A spherical aberration diagram and an astigmatism diagram each illustrate values for a wavelength of 486.1 (nm), a wavelength of 587.6 (nm), and a wavelength of 656.3 (nm). A distortion diagram illustrates a value for the wavelength of 587.6 (nm). In the astigmatism diagram, S indicates a value on a sagittal image plane, and T indicates a value on a tangential image plane. This is similarly applicable to aberration diagrams of other Examples below.

As can be appreciated from each of the aberration diagrams, it is apparent that Example 1-1 has a favorable optical performance.

### Example 1-2

Table 4 describes basic lens data of the eyepiece according to Example 1-2. Further, Table 5 and Table 6 describe aspherical surface data. Table 5 describes the aspherical surface data of standard lens surfaces. Table 6 describes the aspherical surface data of Fresnel lens surfaces.

TABLE 4
Example 1-2 Lens Data

| Si | | Ri | | Ndi | νdi |
|---|---|---|---|---|---|
| Surface | | Curvature | Di | Refractive | Abbe's |
| number | COMMENT | radius | Spacing | index | number |
| 1 | E.P. (Stop) | ∞ | 13.000 | — | — |
| 2 | Standard | 35.857 | 1.980 | 1.535 | 55.710 |
| | lens surface | | | | |
| 3 | Fresnel | −24.533 | 0.500 | — | — |
| | lens surface | | | | |
| 4 | Fresnel | 18.123 | 5.000 | 1.535 | 55.710 |
| | lens surface | | | | |
| 5 | Standard | 19.350 | 15.567 | — | — |
| | lens surface | | | | |
| 6 | Cover glass | ∞ | 0.700 | 1.517 | 64.167 |
| 7 | Image plane | ∞ | — | — | — |

TABLE 5
Example 1-2 Aspherical Surface Data of Standard Lens Surfaces

| Si | K | 3rd order | 4th order | 5th order |
|---|---|---|---|---|
| 2 | −107.138 | 4.559E−04 | −7.421E−05 | −5.879E−07 |
| 5 | −50.486 | 1.064E−03 | 2.342E−05 | −6.500E−06 |
| Si | 6th order | 7th order | 8th order | 9th order |
| 2 | 1.049E−07 | 2.246E−09 | 1.713E−10 | 4.370E−13 |
| 5 | 1.869E−07 | −4.991E−09 | −2.744E−10 | 2.812E−11 |

TABLE 6
Example 1-2 Aspherical Surface Data of Fresnel Lens Surfaces

| Si | K | 4th order | 6th order | 8th order |
|---|---|---|---|---|
| 3 | 0.113 | −4.79E−05 | 8.88E−08 | 1.02E−10 |
| 4 | −2.770 | 5.41E−05 | −8.86E−08 | — |
| Si | 10th order | 12th order | 14th order | 16th order |
| 3 | — | — | — | — |
| 4 | — | — | — | — |

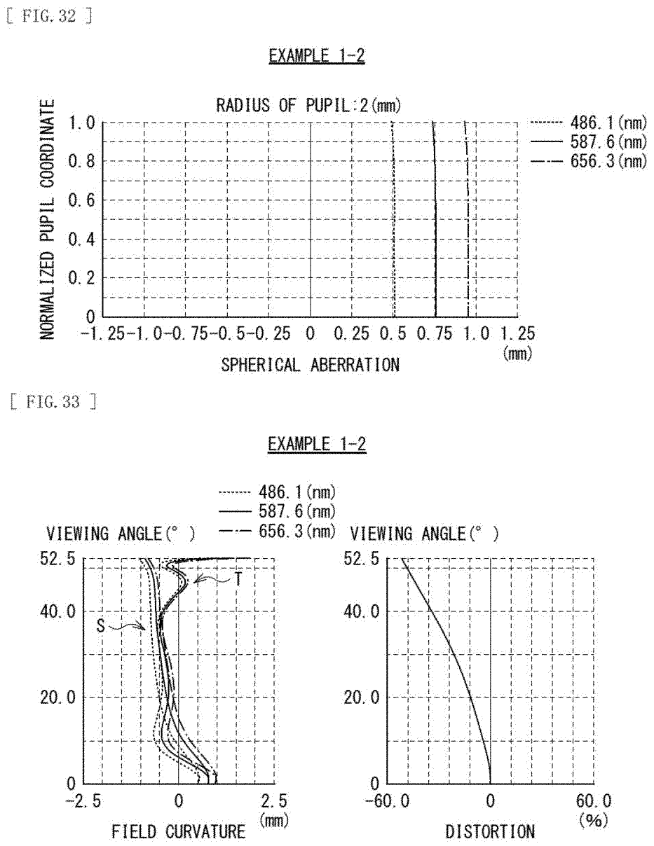

FIG. 31 illustrates a lens cross-section of the eyepiece according to Example 1-2. FIGS. 32 and 33 illustrate various aberrations of the eyepiece according to Example 1-2.

As can be appreciated from each of the aberration diagrams, it is apparent that the eyepiece according to Example 1-2 has a favorable optical performance.

### Example 1-3

Table 7 describes basic lens data of the eyepiece according to Example 1-3. Further, Table 8 and Table 9 describe aspherical surface data. Table 8 describes the aspherical surface data of standard lens surfaces. Table 9 describes the aspherical surface data of Fresnel lens surfaces.

TABLE 7
Example 1-3 Lens Data

| Si | | Ri | | Ndi | νdi |
|---|---|---|---|---|---|
| Surface | | Curvature | Di | Refractive | Abbe's |
| number | COMMENT | radius | Spacing | index | number |
| 1 | E.P. (Stop) | ∞ | 11.000 | — | — |
| 2 | Standard | 37.242 | 1.980 | 1.535 | 55.710 |
| | lens surface | | | | |
| 3 | Fresnel | −21.910 | 0.500 | — | — |
| | lens surface | | | | |
| 4 | Fresnel | 16.589 | 5.000 | 1.535 | 55.710 |
| | lens surface | | | | |
| 5 | Standard | 17.593 | 14.160 | — | — |
| | lens surface | | | | |
| 6 | Cover glass | ∞ | 0.700 | 1.517 | 64.167 |
| 7 | Image plane | ∞ | — | — | — |

TABLE 8
Example 1-3 Aspherical Surface Data of Standard Lens Surfaces

| Si | K | 3rd order | 4th order | 5th order |
|---|---|---|---|---|
| 2 | −228.336 | 5.765E−04 | −6.967E−05 | −3.576E−07 |
| 5 | −52.896 | 9.867E−04 | 2.738E−05 | −6.187E−06 |
| Si | 6th order | 7th order | 8th order | 9th order |
| 2 | 1.007E−07 | 1.237E−09 | 1.101E−10 | −1.700E−12 |
| 5 | 1.679E−07 | −5.950E−09 | −2.375E−10 | 3.314E−11 |

TABLE 9
Example 1-3 Aspherical Surface Data of Fresnel Lens Surfaces

| Si | K | 4th order | 6th order | 8th order |
|---|---|---|---|---|
| 3 | −0.784 | −4.29E−05 | 4.79E−08 | 7.55E−11 |
| 4 | −2.604 | 4.60E−05 | −5.74E−08 | — |
| Si | 10th order | 12th order | 14th order | 16th order |
| 3 | — | — | — | — |
| 4 | — | — | — | — |

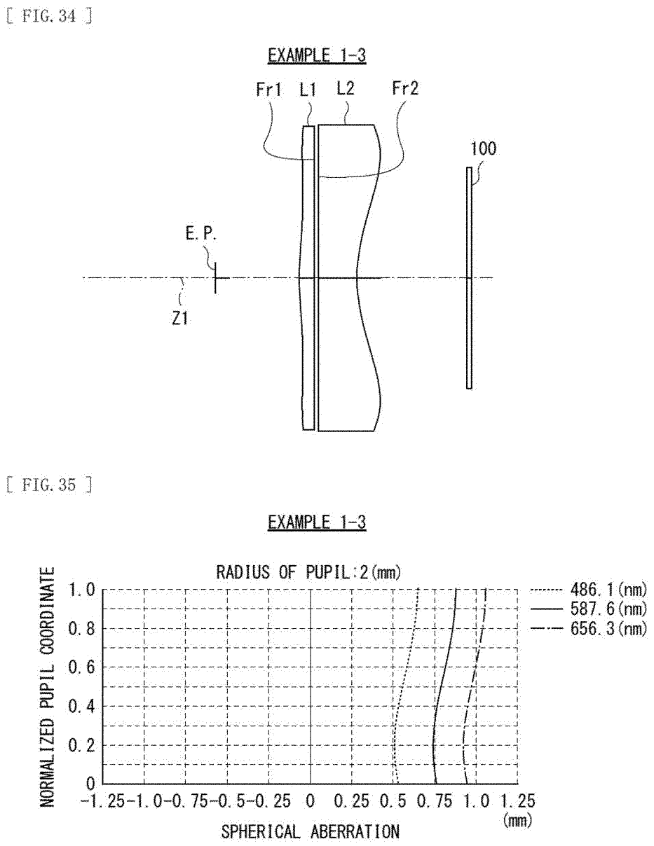

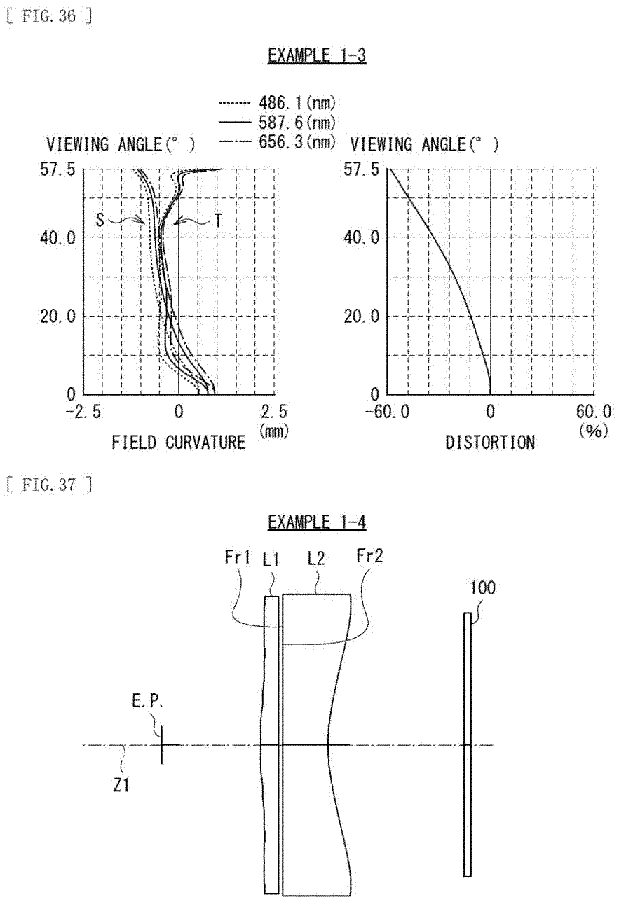

FIG. 34 illustrates a lens cross-section of the eyepiece according to Example 1-3. FIGS. 35 and 36 illustrate various aberrations of the eyepiece according to Example 1-3.

As can be appreciated from each of the aberration diagrams, it is apparent that the eyepiece according to Example 1-3 has a favorable optical performance.

### Example 1-4

Table 10 describes basic lens data of the eyepiece according to Example 1-4. Further, Table 11 and Table 12 describe aspherical surface data. Table 11 describes the aspherical surface data of standard lens surfaces. Table 12 describes the aspherical surface data of Fresnel lens surfaces.

TABLE 10
Example 1-4 Lens Data

| Si | | Ri | | Ndi | νdi |
|---|---|---|---|---|---|
| Surface | | Curvature | Di | Refractive | Abbe's |
| number | COMMENT | radius | Spacing | index | number |
| 1 | E.P. (Stop) | ∞ | 11.000 | — | — |
| 2 | Standard | 33.155 | 1.980 | 1.535 | 55.710 |
| | lens surface | | | | |
| 3 | Fresnel | −23.475 | 0.500 | — | — |
| | lens surface | | | | |
| 4 | Fresnel | 18.607 | 5.000 | 1.535 | 55.710 |
| | lens surface | | | | |
| 5 | Standard | 19.453 | 15.112 | — | — |
| | lens surface | | | | |
| 6 | Cover glass | ∞ | 0.700 | 1.517 | 64.167 |
| 7 | Image plane | ∞ | — | — | — |

TABLE 11
Example 1-4 Aspherical Surface Data of Standard Lens Surfaces

| Si | K | 3rd order | 4th order | 5th order |
|---|---|---|---|---|
| 2 | −163.149 | 6.228E−04 | −1.312E−04 | 1.042E−05 |
| 5 | −74.969 | 1.542E−03 | −2.263E−04 | 4.526E−05 |
| Si | 6th order | 7th order | 8th order | 9th order |
| 2 | −1.226E−06 | 9.065E−08 | −6.565E−10 | −2.659E−10 |
| 5 | −6.299E−06 | 5.039E−07 | −2.444E−08 | 6.682E−10 |

TABLE 12
Example 1-4 Aspherical Surface Data of Fresnel Lens Surfaces

| Si | K | 4th order | 6th order | 8th order |
|---|---|---|---|---|
| 3 | 0.173 | −5.08E−05 | 1.18E−07 | 1.60E−10 |
| 4 | −2.681 | 4.63E−05 | −7.75E−08 | — |
| Si | 10th order | 12th order | 14th order | 16th order |
| 3 | — | — | — | — |
| 4 | — | — | — | — |

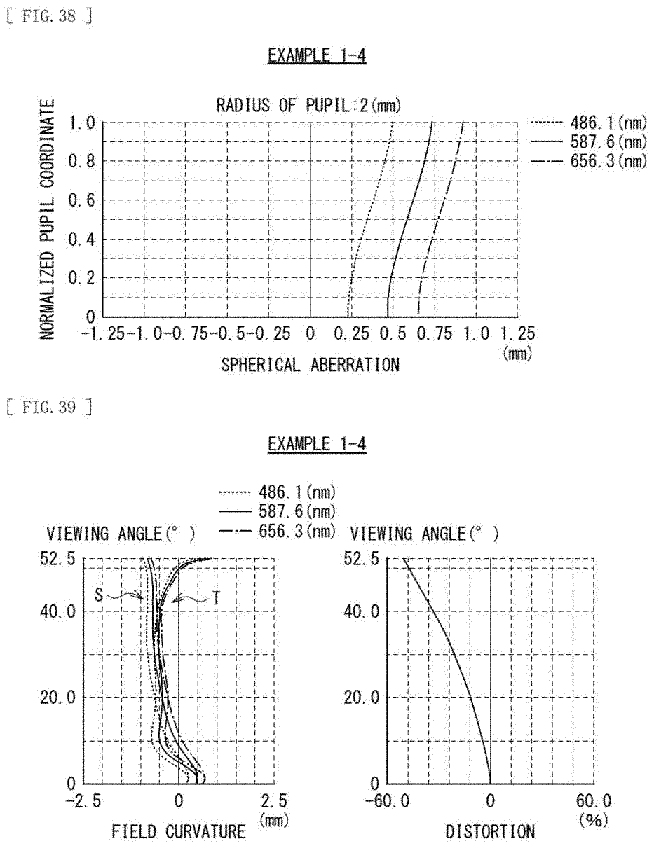

FIG. 37 illustrates a lens cross-section of the eyepiece according to Example 1-4. FIGS. 38 and 39 illustrate various aberrations of the eyepiece according to Example 1-4.

As can be appreciated from each of the aberration diagrams, it is apparent that the eyepiece according to Example 1-4 has a favorable optical performance.

### Example 1-5

Table 13 describes basic lens data of the eyepiece according to Example 1-5. Further, Table 14 and Table 15 describe aspherical surface data. Table 14 describes the aspherical surface data of standard lens surfaces. Table 15 describes the aspherical surface data of Fresnel lens surfaces.

TABLE 13
Example 1-5 Lens Data

| Si | | Ri | | Ndi | νdi |
|---|---|---|---|---|---|
| Surface | | Curvature | Di | Refractive | Abbe's |
| number | COMMENT | radius | Spacing | index | number |
| 1 | E.P. (Stop) | ∞ | 13.000 | — | — |
| 2 | Standard | 33.352 | 2.131 | 1.535 | 55.710 |
| | lens surface | | | | |
| 3 | Fresnel | −18.455 | 0.493 | — | — |
| | lens surface | | | | |
| 4 | Fresnel | 13.796 | 4.492 | 1.535 | 55.710 |
| | lens surface | | | | |
| 5 | Standard | 14.318 | 11.678 | — | — |
| | lens surface | | | | |
| 6 | Cover glass | ∞ | 0.700 | 1.517 | 64.167 |
| 7 | Image plane | ∞ | — | — | — |

TABLE 14
Example 1-5 Aspherical Surface Data of Standard Lens Surfaces

| Si | K | 3rd order | 4th order | 5th order | 6th order | 7th order | 8th order | 9th order |
|---|---|---|---|---|---|---|---|---|
| 2 | −62.726 | 4.944E−04 | −7.616E−05 | −6.516E−07 | 1.081E−07 | 2.292E−09 | 1.403E−10 | −2.495E−12 |
| 5 | −17.714 | 1.405E−03 | 1.849E−05 | −9.195E−06 | 1.410E−07 | −3.116E−09 | −1.461E−10 | 5.071E−11 |

TABLE 15
Example 1-5 Aspherical Surface Data of Fresnel Lens Surfaces

| Si | K | 4th order | 6th order | 8th order | 10th order | 12th order | 14th order | 16th order |
|---|---|---|---|---|---|---|---|---|
| 3 | −0.655 | −3.38E−05 | 5.04E−08 | 7.91E−11 | — | — | — | — |
| 4 | −1.793 | 6.62E−05 | −7.07E−08 | — | — | — | — | — |

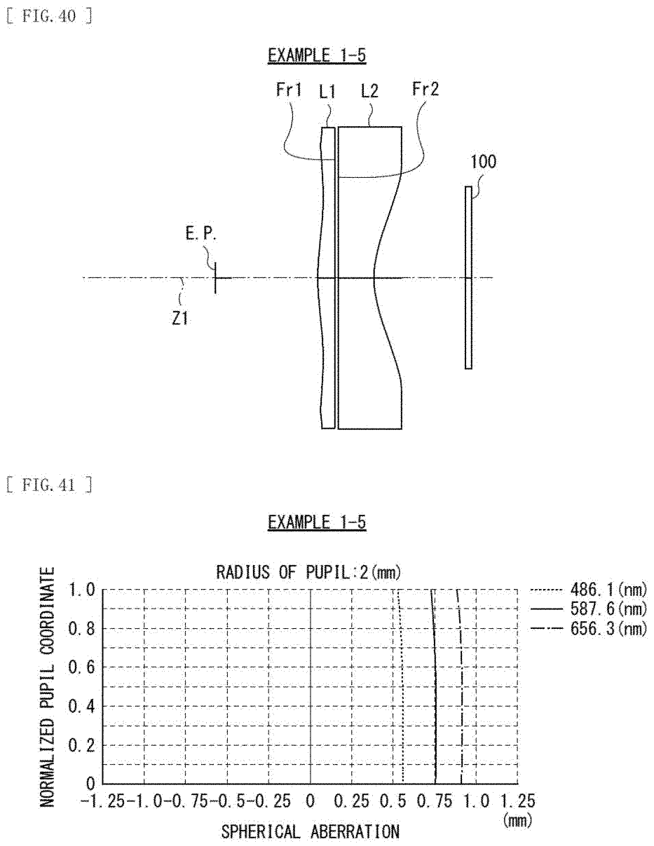

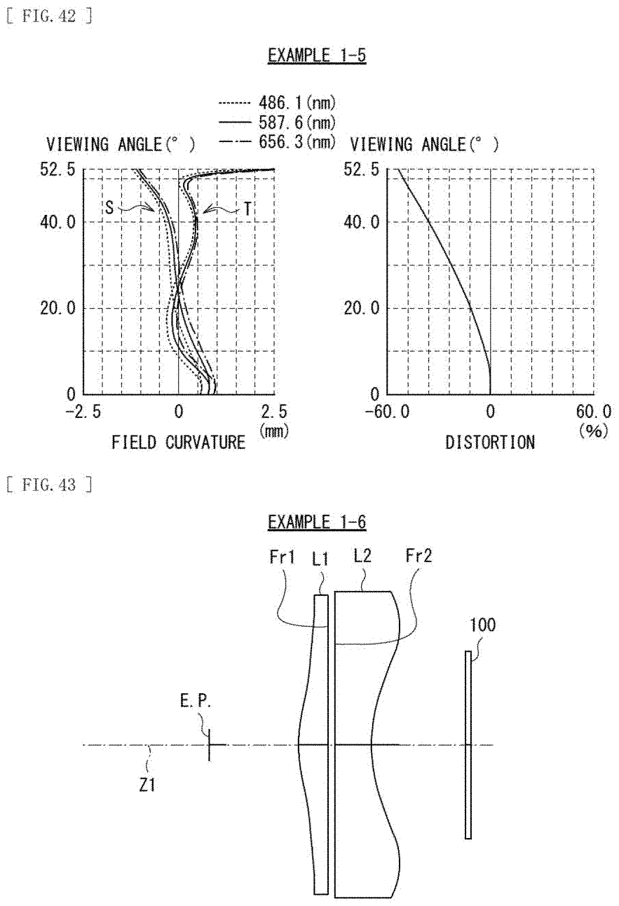

FIG. 40 illustrates a lens cross-section of the eyepiece according to Example 1-5. FIGS. 41 and 42 illustrate various aberrations of the eyepiece according to Example 1-5.

As can be appreciated from each of the aberration diagrams, it is apparent that the eyepiece according to Example 1-5 has a favorable optical performance.

### Example 1-6

Table 16 describes basic lens data of the eyepiece according to Example 1-6. Further, Table 16 and Table 17 describe aspherical surface data. Table 16 describes the aspherical surface data of standard lens surfaces. Table 17 describes the aspherical surface data of Fresnel lens surfaces.

TABLE 16
Example 1-6 Lens Data

| Si | | Ri | | Ndi | vdi |
|---|---|---|---|---|---|
| Surface | | Curvature | Di | Refractive | Abbe's |
| number | COMMENT | radius | Spacing | index | number |
| 1 | E.P. (Stop) | ∞ | 11.000 | — | — |
| 2 | Standard | 20.412 | 3.588 | 1.535 | 55.710 |
| | lens surface | | | | |
| 3 | Fresnel | −23.634 | 0.833 | — | — |
| | lens surface | | | | |
| 4 | Fresnel | 19.349 | 4.499 | 1.535 | 55.710 |
| | lens surface | | | | |
| 5 | Standard | 17.706 | 11.574 | — | — |
| | lens surface | | | | |
| 6 | Cover glass | ∞ | 0.700 | 1.517 | 64.167 |
| 7 | Image plane | ∞ | — | — | — |

TABLE 17
Example 1-6 Aspherical Surface Data of Standard Lens Surfaces

| Si | K | 3rd order | 4th order | 5th order | 6th order | 7th order | 8th order | 9th order |
|---|---|---|---|---|---|---|---|---|
| 2 | −76.576 | 2.468E−03 | −1.979E−04 | −8.762E−06 | 1.012E−06 | −9.128E−09 | 1.202E−09 | −1.866E−10 |
| 5 | −56.201 | 1.338E−03 | 8.366E−06 | 1.131E−05 | −1.482E−06 | −1.029E−08 | 3.240E−09 | −1.189E−11 |

TABLE 18
Example 1-6 Aspherical Surface Data of Fresnel Lens Surfaces

| Si | K | 4th order | 6th order | 8th order | 10th order | 12th order | 14th order | 16th order |
|---|---|---|---|---|---|---|---|---|
| 3 | 0.046 | −3.79E−05 | 5.82E−08 | 9.99E−11 | — | — | — | — |
| 4 | −1.588 | 8.82E−05 | −1.22E−07 | — | — | — | — | — |

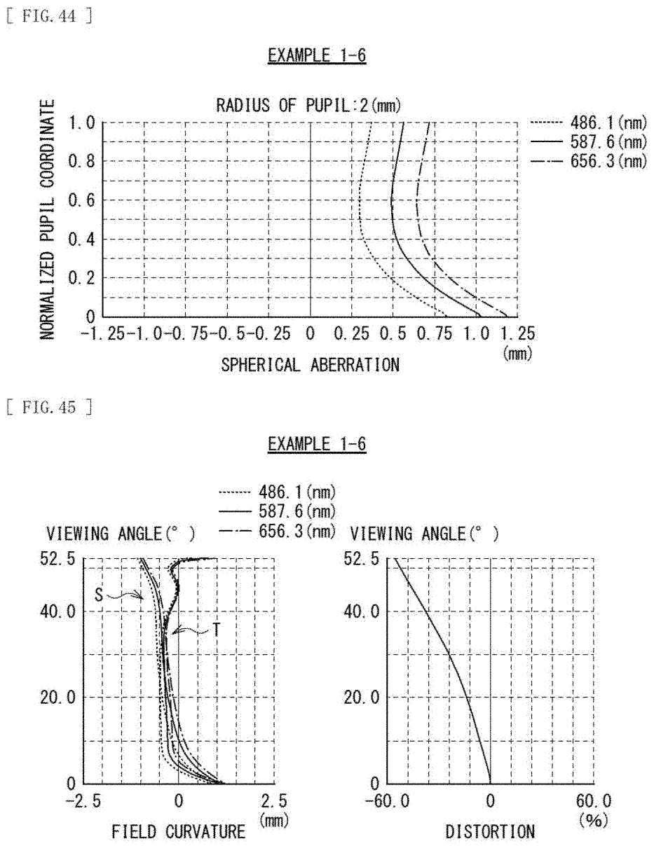

FIG. 43 illustrates a lens cross-section of the eyepiece according to Example 1-6. FIGS. 44 and 45 illustrate various aberrations of the eyepiece according to Example 1-6.

As can be appreciated from each of the aberration diagrams, it is apparent that the eyepiece according to Example 1-6 has a favorable optical performance.

### Example 1-7

Table 19 describes basic lens data of the eyepiece according to Example 1-7. Further, Table 20 and Table 21 describe aspherical surface data. Table 20 describes the aspherical surface data of standard lens surfaces. Table 21 describes the aspherical surface data of Fresnel lens surfaces.

TABLE 19
Example 1-7 Lens Data

| Si | | Ri | | Ndi | vdi |
|---|---|---|---|---|---|
| Surface | | Curvature | Di | Refractive | Abbe's |
| number | COMMENT | radius | Spacing | index | number |
| 1 | E.P. (Stop) | ∞ | 11.000 | — | — |
| 2 | Standard | 34.068 | 2.109 | 1.535 | 55.710 |
| | lens surface | | | | |
| 3 | Fresnel | −18.363 | 0.484 | — | — |
| | lens surface | | | | |
| 4 | Fresnel | 13.546 | 4.495 | 1.535 | 55.710 |
| | lens surface | | | | |
| 5 | Standard | 14.092 | 11.541 | — | — |
| | lens surface | | | | |
| 6 | Cover glass | ∞ | 0.700 | 1.517 | 64.167 |
| 7 | Image plane | ∞ | — | — | — |

TABLE 20
Example 1-7 Aspherical Surface Data of Standard Lens Surfaces

| Si | K | 3rd order | 4th order | 5th order | 6th order | 7th order | 8th order | 9th order |
|---|---|---|---|---|---|---|---|---|
| 2 | −63.089 | 4.937E−04 | −7.658E−05 | −6.465E−07 | 1.083E−07 | 2.267E−09 | 1.382E-10 | −2.433E−12 |
| 5 | −17.648 | 1.402E−03 | 1.793E−05 | −9.184E−06 | 1.420E−07 | −3.136E−09 | −1.525E−10 | 5.037E−11 |

TABLE 21
Example 1-7 Aspherical Surface Data of Fresnel Lens Surfaces

| Si | K | 4th order | 6th order | 8th order | 10th order | 12th order | 14th order | 16th order |
|---|---|---|---|---|---|---|---|---|
| 3 | −0.646 | −3.39E−05 | 4.99E−08 | 7.46E−11 | — | — | — | — |
| 4 | −1.763 | 6.66E−05 | −6.97E−08 | — | — | — | — | — |

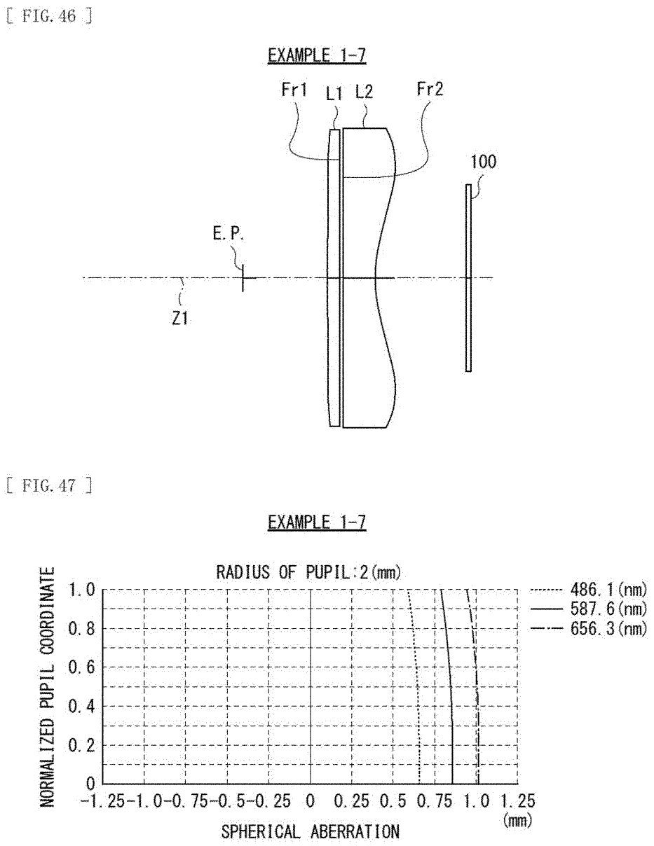

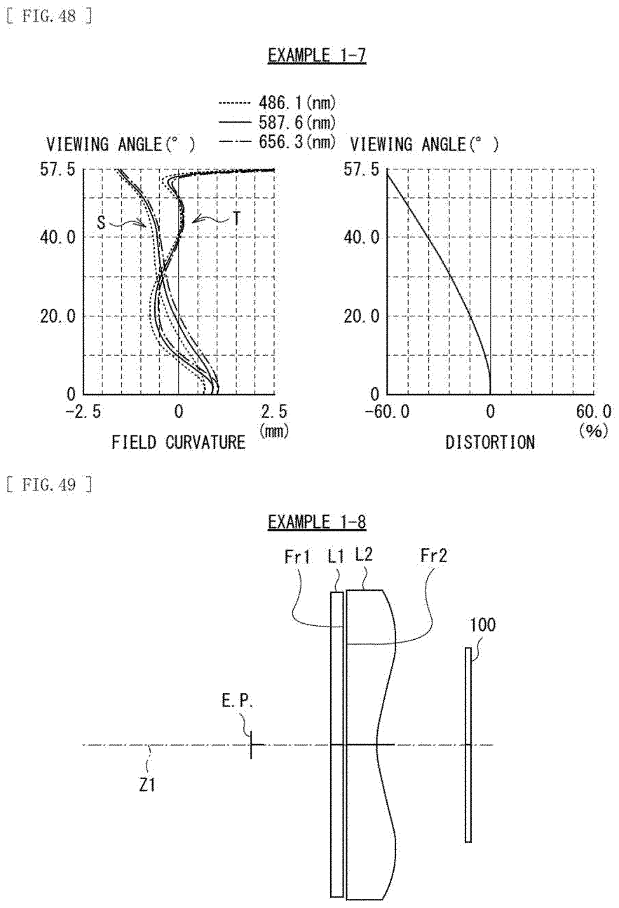

FIG. 46 illustrates a lens cross-section of the eyepiece according to Example 1-7. FIGS. 47 and 48 illustrate various aberrations of the eyepiece according to Example 1-7.

As can be appreciated from each of the aberration diagrams, it is apparent that the eyepiece according to Example 1-7 has a favorable optical performance.

### Example 1-8

Table 22 describes basic lens data of the eyepiece according to Example 1-8. Further, Table 23 and Table 24 describe aspherical surface data. Table 23 describes the aspherical surface data of standard lens surfaces. Table 24 describes the aspherical surface data of Fresnel lens surfaces.

TABLE 22
Example 1-8 Lens Data

| Si | | Ri | | Ndi | vdi |
|---|---|---|---|---|---|
| Surface | | Curvature | Di | Refractive | Abbe's |
| number | COMMENT | radius | Spacing | index | number |
| 1 | E.P. (Stop) | ∞ | 13.000 | — | — |
| 2 | Standard | ∞ | 1.980 | 1.535 | 55.710 |
| | lens surface | | | | |
| 3 | Fresnel | −17.505 | 0.500 | — | — |
| | lens surface | | | | |
| 4 | Fresnel | 12.769 | 5.000 | 1.535 | 55.710 |
| | lens surface | | | | |
| 5 | Standard | 15.438 | 14.517 | — | — |
| | lens surface | | | | |
| 6 | Cover glass | ∞ | 0.700 | 1.517 | 64.167 |
| 7 | Image plane | ∞ | — | — | — |

TABLE 23
Example 1-8 Aspherical Surface Data of Standard Lens Surfaces

| Si | K | 3rd order | 4th order | 5th order | 6th order | 7th order | 8th order | 9th order |
|---|---|---|---|---|---|---|---|---|
| 5 | −1.561 | −1.946E−04 | −3.304E−04 | 4.516E−05 | −2.165E−06 | −4.063E−08 | 7.467E−09 | −2.477E−10 |

TABLE 24
Example 1-8 Aspherical Surface Data of Fresnel Lens Surfaces

| Si | K | 4th order | 6th order | 8th order | 10th order | 12th order | 14th order | 16th order |
|---|---|---|---|---|---|---|---|---|
| 3 | −0.888 | −8.33E−06 | 1.48E−08 | 2.91E−11 | — | — | — | — |
| 4 | −2.956 | 3.18E−05 | −2.80E−08 | — | — | — | — | — |

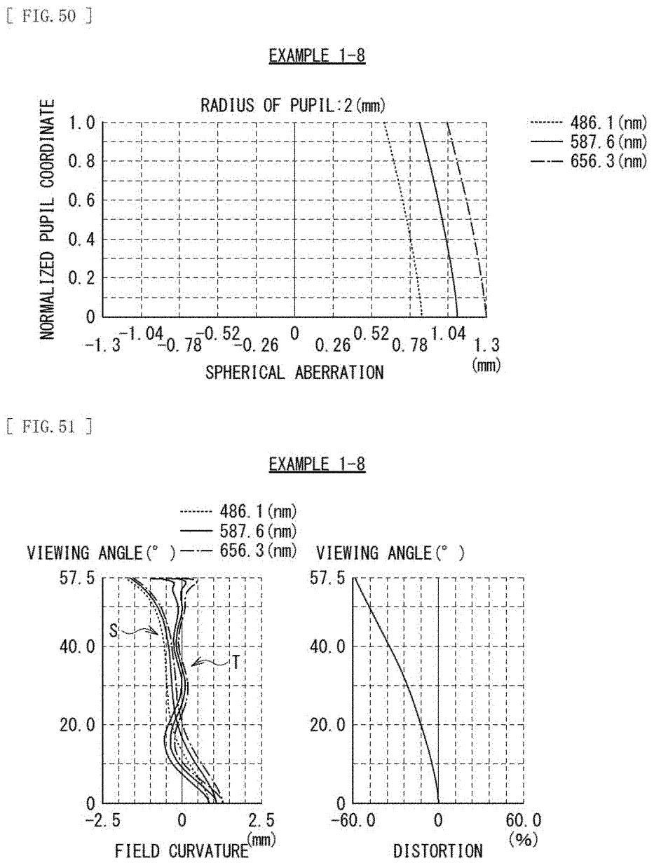

FIG. 49 illustrates a lens cross-section of the eyepiece according to Example 1-8. FIGS. 50 and 51 illustrate various aberrations of the eyepiece according to Example 1-8.

As can be appreciated from each of the aberration diagrams, it is apparent that the eyepiece according to Example 1-8 has a favorable optical performance.

### Example 2

Table 25 describes basic lens data of the eyepiece according to Example 2. Further, Table 26 and Table 27 describe aspherical surface data. Table 26 describes the aspherical surface data of standard lens surfaces. Table 27 describes the aspherical surface data of Fresnel lens surfaces.

TABLE 25
Example 2 Lens Data

| Si | | Ri | | Ndi | vdi |
|---|---|---|---|---|---|
| Surface | | Curvature | Di | Refractive | Abbe's |
| number | COMMENT | radius | Spacing | index | number |
| 1 | E.P. (Stop) | ∞ | 13.000 | — | — |
| 2 | Standard | ∞ | 2.018 | 1.531 | 56.044 |
| | lens surface | | | | |
| 3 | Fresnel | −15.618 | 0.200 | — | — |
| | lens surface | | | | |
| 4 | Fresnel | 12.089 | 4.878 | 1.531 | 56.044 |
| | lens surface | | | | |
| 5 | Standard | 10.578 | 14.593 | — | — |
| | lens surface | | | | |
| 6 | Standard | 13.582 | 11.930 | 1.531 | 56.044 |
| | lens surface | | | | |
| 7 | Standard | ∞ | 3.281 | — | — |
| | lens surface | | | | |
| 8 | Cover glass | ∞ | 0.700 | 1.517 | 64.167 |
| 9 | Image plane | ∞ | — | — | — |

TABLE 26
Example 2 Aspherical Surface Data of Standard Lens Surfaces

| Si | K | 3rd order | 4th order | 5th order |
|---|---|---|---|---|
| 2 | 0.000 | 5.722E−04 | −1.475E−04 | 1.489E−05 |
| 5 | −22.326 | 7.230E−03 | −1.134E−03 | 5.779E−05 |
| 6 | −18.594 | 1.453E−03 | −1.878E−04 | 6.685E−06 |
| 7 | 0.000 | −1.353E−02 | 2.682E−03 | −2.065E−04 |
| Si | 6th order | 7th order | 8th order | 9th order |
| 2 | −7.201E−07 | 1.800E−08 | −5.115E−10 | 2.141E−11 |
| 5 | −6.966E−07 | −2.887E−08 | 3.253E−10 | 2.521E−11 |
| 6 | 1.741E−07 | −1.374E−10 | −3.028E−10 | −1.780E−11 |
| 7 | 4.284E−06 | 4.870E−07 | −6.346E−09 | −1.804E−09 |
| Si | 10th order | 11th order | 12th order | 13th order |
| 2 | −1.241E−13 | −9.854E−15 | −1.806E−16 | 1.551E−18 |
| 5 | 2.111E−14 | −1.895E−14 | −3.391E−16 | 1.809E−17 |
| 6 | −5.651E−13 | 3.980E−16 | 1.459E−15 | 1.150E−16 |
| 7 | −6.237E−11 | 2.508E−12 | 3.482E−13 | 1.185E−14 |
| | Si | 14th order | 15th order | 16th order |
| | 2 | 2.289E−19 | 6.411E−21 | −2.200E−22 |
| | 5 | −7.483E−20 | 1.394E−21 | −6.990E−23 |
| | 6 | 5.081E−18 | 3.444E−20 | −2.004E−20 |
| | 7 | −5.865E−16 | −7.211E−17 | 2.377E−18 |

TABLE 27
Example 2 Aspherical Surface Data of Fresnel Lens Surfaces

| Si | K | 4th order | 6th order | 8th order | 10th order | 12th order | 14th order | 16th order |
|---|---|---|---|---|---|---|---|---|
| 3 | −0.924 | 8.461E−06 | 2.586E−08 | −4.659E−11 | 5.579E−14 | −3.649E−17 | −1.174E−21 | 9.551E−24 |
| 4 | −3.837 | 1.368E−05 | −1.841E−09 | −8.294E−12 | 3.157E−15 | 4.844E−18 | −7.725E−21 | 3.929E−24 |

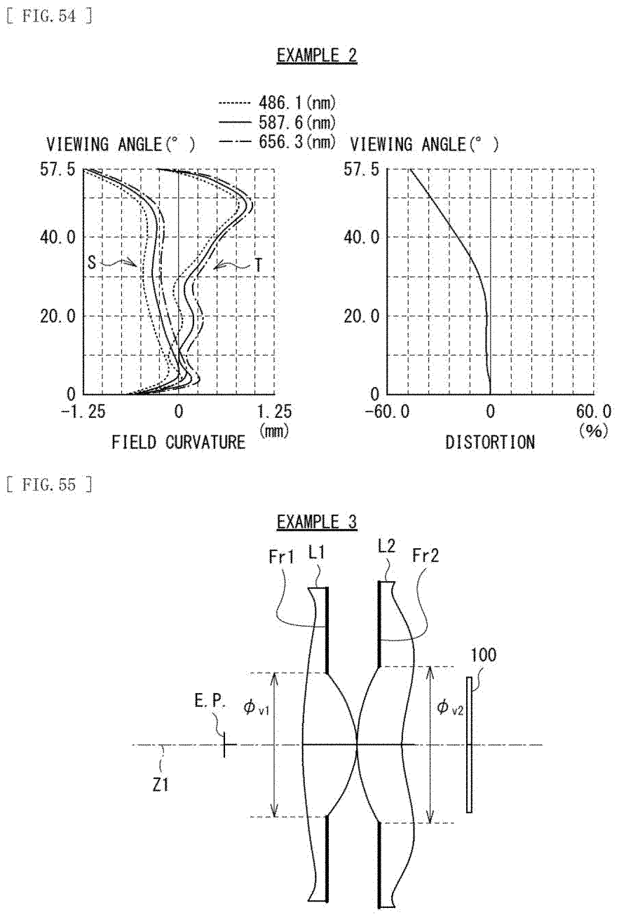

FIG. 52 illustrates a lens cross-section of the eyepiece according to Example 2. FIGS. 53 and 54 illustrate various aberrations of the eyepiece according to Example 2.

As can be appreciated from each of the aberration diagrams, it is apparent that the eyepiece according to Example 2 has a favorable optical performance.

### Example 3

Table 28 describes basic lens data of the eyepiece according to Example 3. Further, Table 29 describes aspherical surface data. Note that, in the eyepiece according to Example 3, the effective diameter φᵥ₁ of the middle region of the L1 (R2) surface of the first lens L1 is 25.004, and the effective diameter φᵥ₂ of the middle region of the L2(R1) surface of the second lens L2 is 27.054. The effective diameters φᵥ₁ and φᵥ₂ of the middle region are each an effective range that allows a bundle of light rays entering a pupil at an angle of 35° to pass therethrough in a state where the pupil center is on the optical axis.

TABLE 28
Example 3 Lens Data

| Si | | Ri | | Ndi | vdi |
|---|---|---|---|---|---|
| Surface | | Curvature | Di | Refractive | Abbe's |
| number | COMMENT | radius | Spacing | index | number |
| 1 | E.P. (Stop) | ∞ | 13.000 | — | — |
| 2 | Standard | 61.400 | 9.004 | 1.535 | 55.600 |
| (Middle) | lens surface | | | | |
| 3 | Standard | −12.371 | 0.100 | — | — |
| (Middle) | lens surface | | | | |
| 2 | Standard | 61.400 | 4.062 | 1.535 | 55.600 |
| (Peripheral) | lens surface | | | | |
| 3 | Fresnel | −17.137 | 8.657 | — | — |
| (Peripheral) | lens surface | | | | |
| 4 | Standard | 23.573 | 7.343 | 1.661 | 20.350 |
| (Middle) | lens surface | | | | |
| 5 | Standard | 16.008 | 10.795 | — | — |
| (Middle) | lens surface | | | | |
| 4 | Fresnel | 15.594 | 3.726 | 1.661 | 20.350 |
| (Peripheral) | lens surface | | | | |
| 5 | Standard | 16.008 | 10.795 | | |
| (Peripheral) | lens surface | | | | |
| 8 | Cover glass | ∞ | 0.700 | 1.517 | 64.167 |
| 9 | Image plane | ∞ | — | — | — |

TABLE 29
Example 3 Aspherical Surface Data of Standard Lens Surfaces
and Fresnel Lens Surfaces

| Si | K | 4th order | 6th order | 8th order |
|---|---|---|---|---|
| 2 | −6.653 | −1.36E−05 | 1.53E−08 | 2.75E−11 |
| (Middle) | | | | |
| 3 | −0.137 | 1.76E−04 | −5.79E−07 | 1.05E−09 |
| (Middle) | | | | |
| 2 | −6.653 | −1.36E−05 | 1.53E−08 | 2.75E−11 |
| (Peripheral) | | | | |
| 3 | −0.809 | −6.80E−05 | 1.03E−07 | 2.06E−11 |
| (Peripheral) | | | | |
| 4 | 0.000 | −2.52E−05 | 2.77E−07 | −1.46E−09 |
| (Middle) | | | | |
| 5 | −12.426 | −2.10E−05 | −1.28E−08 | 4.96E−12 |
| (Middle) | | | | |
| 4 | −3.372 | −1.55E−05 | −1.43E−08 | 2.30E−11 |
| (Peripheral) | | | | |
| 5 | −12.426 | −2.10E−05 | −1.28E−08 | 4.96E−12 |
| (Peripheral) | | | | |
| Si | 10th order | 12th order | 14th order | 16th order |
| 2 | 7.36E−15 | −9.46E−17 | −1.61E−19 | 2.39E−22 |
| (Middle) | | | | |
| 3 | 2.13E−11 | −1.74E−13 | 8.00E−16 | — |
| (Middle) | | | | |
| 2 | 7.36E−15 | −9.46E−17 | −1.61E−19 | 2.39E−22 |
| (Peripheral) | | | | |
| 3 | −6.08E−14 | — | — | — |
| (Peripheral) | | | | |
| 4 | −1.04E−12 | 1.26E−14 | 1.09E−16 | −4.47E−19 |
| (Middle) | | | | |
| 5 | 1.16E−14 | 3.64E−17 | −1.31E−20 | 7.15E−24 |
| (Middle) | | | | |
| 4 | 1.97E−14 | 4.92E−18 | — | — |
| (Peripheral) | | | | |
| 5 | 1.16E−14 | 3.64E−17 | −1.31E−20 | 7.15E−24 |
| (Peripheral) | | | | |

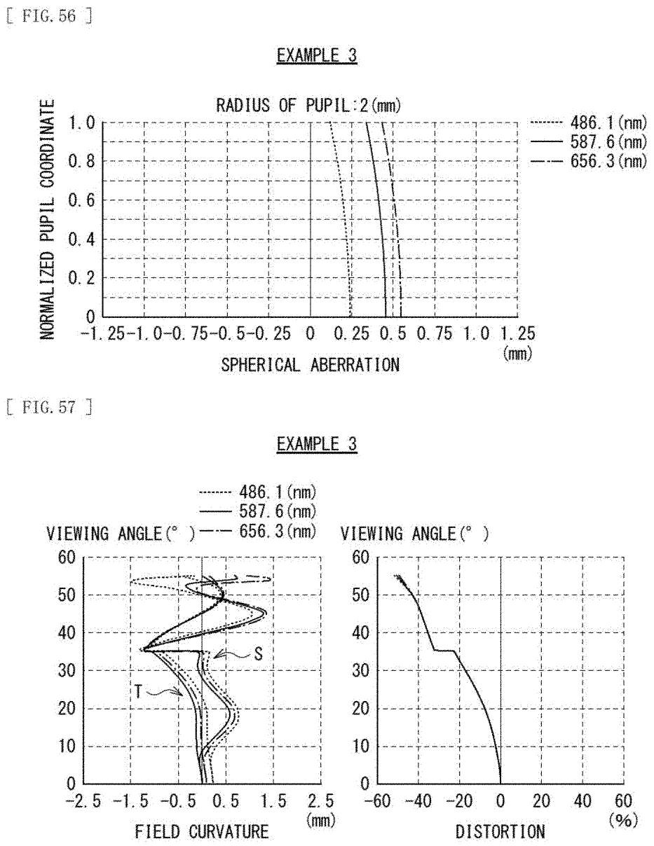

FIG. 55 illustrates a lens cross-section of the eyepiece according to Example 3. FIGS. 56 and 57 illustrate various aberrations of the eyepiece according to Example 3.

As can be appreciated from each of the aberration diagrams, it is apparent that the eyepiece according to Example 3 has a favorable optical performance.

### Example 4

Table 30 describes basic lens data of the eyepiece according to Example 4. Further, Table 31 describes aspherical surface data. Note that, in the eyepiece according to Example 4, the effective diameter φᵥ₁ of the middle region of the L1(R2) surface of the first lens L1 is 24.116, and the effective diameter φᵥ₂ of the middle region of the L2(R1) surface of the second lens L2 is 27.038. The effective diameters φᵥ₁ and φᵥ₂ of the middle region are each an effective range that allows a bundle of light rays entering a pupil at an angle of 35° to pass therethrough in a state where the pupil center is on the optical axis.

TABLE 30
Example 4 Lens Data

| Si | | Ri | | Ndi | vdi |
|---|---|---|---|---|---|
| Surface | | Curvature | Di | Refractive | Abbe's |
| number | COMMENT | radius | Spacing | index | number |
| 1 | E.P. (Stop) | ∞ | 13.000 | — | — |
| 2 | Standard | 56.452 | 8.046 | 1.535 | 55.600 |
| (Middle) | lens surface | | | | |
| 3 | Standard | −12.553 | 0.200 | — | — |
| (Middle) | lens surface | | | | |
| 2 | Standard | 56.452 | 3.917 | 1.535 | 55.600 |
| (Peripheral) | lens surface | | | | |
| 3 | Fresnel | −18.347 | 7.129 | — | — |
| (Peripheral) | lens surface | | | | |
| 4 | Standard | 78.541 | 7.954 | 1.535 | 55.600 |
| (Middle) | lens surface | | | | |
| 5 | Standard | −775.333 | 0.200 | — | — |
| (Middle) | lens surface | | | | |
| 4 | Fresnel | 17.901 | 5.153 | 1.661 | 20.350 |
| (Peripheral) | lens surface | | | | |
| 5 | Standard | −775.333 | 0.200 | | |
| (Peripheral) | lens surface | | | | |
| 6 | Standard | 39.953 | 3.000 | 1.535 | 55.600 |
| | lens surface | | | | |
| 7 | Standard | 16.430 | 9.215 | | |
| | lens surface | | | | |
| 8 | Cover glass | ∞ | 0.700 | 1.517 | 64.167 |
| 9 | Image plane | ∞ | — | — | — |

TABLE 31
Example 4 Aspherical Surface Data of Fresnel Lens Surfaces
and Standard Lens Surfaces

| Si | K | 4th order | 6th order | 8th order |
|---|---|---|---|---|
| 2 | −24.721 | −6.58E−06 | 6.47E−09 | 6.68E−12 |
| (Middle) | | | | |
| 3 | −0.412 | 1.75E−04 | −4.63E−07 | 2.18E−09 |
| (Middle) | | | | |
| 2 | −24.721 | −6.58E−06 | 6.47E−09 | 6.68E−12 |
| (Peripheral) | | | | |
| 3 | −0.515 | −4.06E−05 | 3.96E−08 | 3.26E−11 |
| (Peripheral) | | | | |
| 4 | 0.000 | 9.13E−05 | −3.55E−08 | −1.06E−09 |
| (Middle) | | | | |
| 5 | 0.000 | −2.10E−06 | −1.11E−08 | −1.08E−11 |
| (Middle) | | | | |
| 4 | −5.191 | −1.26E−05 | −8.14E−09 | 1.62E−11 |
| (Peripheral) | | | | |
| 5 | 0.000 | −2.10E−06 | −1.11E−08 | −1.08E−11 |
| (Peripheral) | | | | |
| 6 | −1.401 | −6.14E−06 | 3.96E−09 | 2.33E−11 |
| 7 | −0.398 | −1.22E−05 | −3.34E−09 | −3.55E−10 |
| Si | 10th order | 12th order | 14th order | 16th order |
| 2 | 1.39E−16 | −2.01E−17 | −2.61E−20 | 1.54E−23 |
| (Middle) | | | | |
| 3 | 1.13E−11 | −3.14E−13 | 1.26E−15 | — |
| (Middle) | | | | |
| 2 | 1.39E−16 | −2.01E−17 | −2.61E−20 | 1.54E−23 |
| (Peripheral) | | | | |
| 3 | 7.96E−15 | — | — | — |
| (Peripheral) | | | | |
| 4 | −1.92E−12 | 7.47E−15 | 1.10E−16 | −3.00E−19 |
| (Middle) | | | | |
| 5 | 1.63E−15 | 1.99E−17 | 2.42E−20 | 1.18E−23 |
| (Middle) | | | | |
| 4 | −1.94E−15 | 2.74E−17 | — | — |
| (Peripheral) | | | | |
| 5 | 1.63E−15 | 1.99E−17 | 2.42E−20 | 1.18E−23 |
| (Peripheral) | | | | |
| 6 | 3.75E−14 | 8.58E−17 | −5.24E−20 | −8.23E−23 |
| 7 | −2.51E−13 | 8.94E−16 | −1.46E−19 | −3.16E−22 |

FIG. 58 illustrates a lens cross-section of the eyepiece according to Example 4. FIGS. 59 and 60 illustrate various aberrations of the eyepiece according to Example 4.

As can be appreciated from each of the aberration diagrams, it is apparent that the eyepiece according to Example 4 has a favorable optical performance.

### Example 5

Table 32 describes basic lens data of the eyepiece according to Example 5. Further, Table 33 and Table 34 describe aspherical surface data. Table 33 describes the aspherical surface data of standard lens surfaces. Table 34 describes the aspherical surface data of Fresnel lens surfaces.

TABLE 32
Example 5 Lens Data

| Si | | Ri | | Ndi | vdi |
|---|---|---|---|---|---|
| Surface | | Curvature | Di | Refractive | Abbe's |
| number | COMMENT | radius | Spacing | index | number |
| 1 | E.P. (Stop) | ∞ | 13 | — | — |
| 2 | Standard | 25.142 | 2.6 | 1.535 | 55.7 |
| | lens surface | | | | |
| 3 | Fresnel | −55.793 | 0.5 | — | — |
| | lens surface | | | | |
| 4 | Fresnel | 989.892 | 6.2 | 1.535 | 55.7 |
| | lens surface | | | | |
| 5 | Standard | −9.319 | 0.3 | — | — |
| | lens surface | | | | |
| 6 | Standard | 19.692 | 4.0 | 1.661 | 20.4 |
| | lens surface | | | | |
| 7 | Standard | 6.565 | 10.24 | — | — |
| | lens surface | | | | |
| 8 | Image plane | ∞ | — | — | — |

TABLE 33
Example 5 Aspherical Surface Data of Standard Lens Surfaces

| Si | K | 4th order | 6th order | 8th order |
|---|---|---|---|---|
| 2 | −1.41531E−01 | −5.60872E−05 | −1.47092E−07 | 5.65080E−10 |
| 5 | −6.16014E+00 | 4.26767E−05 | −8.50636E−08 | 1.50391E−10 |
| 6 | 0.00000E+00 | −1.25708E−04 | 6.54932E−07 | −1.34825E−09 |
| 7 | −3.80659E+00 | −7.12493E−05 | 1.21842E−06 | −4.81235E−09 |
| Si | 10th order | 12th order | 14th order | 16th order |
| 2 | −5.19171E−13 | 8.06912E−17 | — | — |
| 5 | −1.99063E−13 | 8.85114E−17 | — | — |
| 6 | 2.00606E−13 | −8.35223E−16 | 2.59370E−17 | −6.07490E−20 |
| 7 | 4.31655E−13 | 5.92850E−14 | −9.64301E−17 | −2.31940E−19 |

TABLE 34
Example 5 Aspherical Surface Data of Fresnel Lens Surfaces

| Si | K | 4th order | 6th order | 8th order |
|---|---|---|---|---|
| 3 | −1.09444E+02 | −5.90211E−05 | −5.79537E−08 | 1.97585E−10 |
| 4 | 0.00000E+00 | 6.79511E−05 | −7.93756E−08 | 4.01408E−11 |
| Si | 10th order | 12th order | 14th order | 16th order |
| 3 | 5.77197E−14 | −1.58905E−16 | — | — |
| 4 | 6.37408E−14 | −1.05535E−16 | — | — |

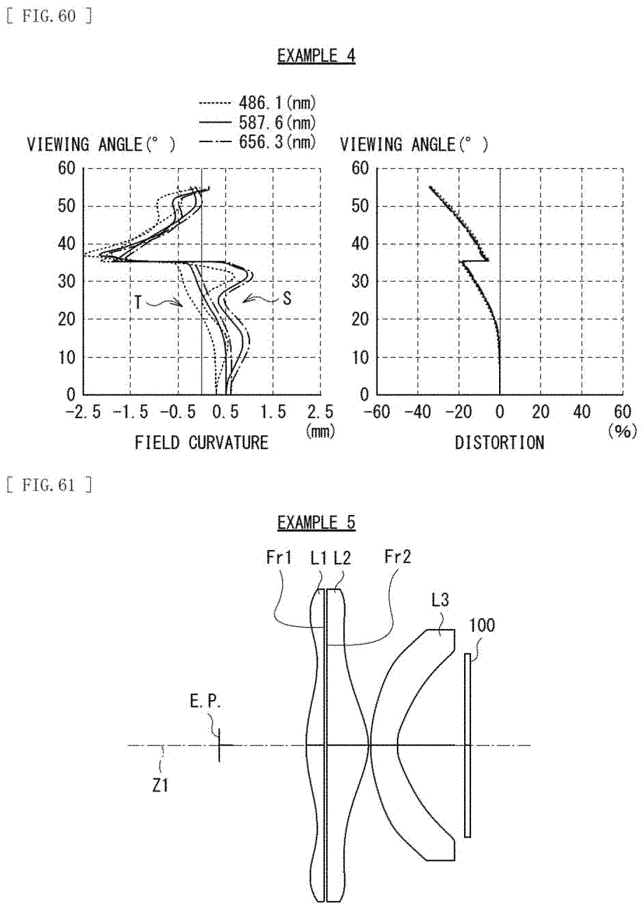

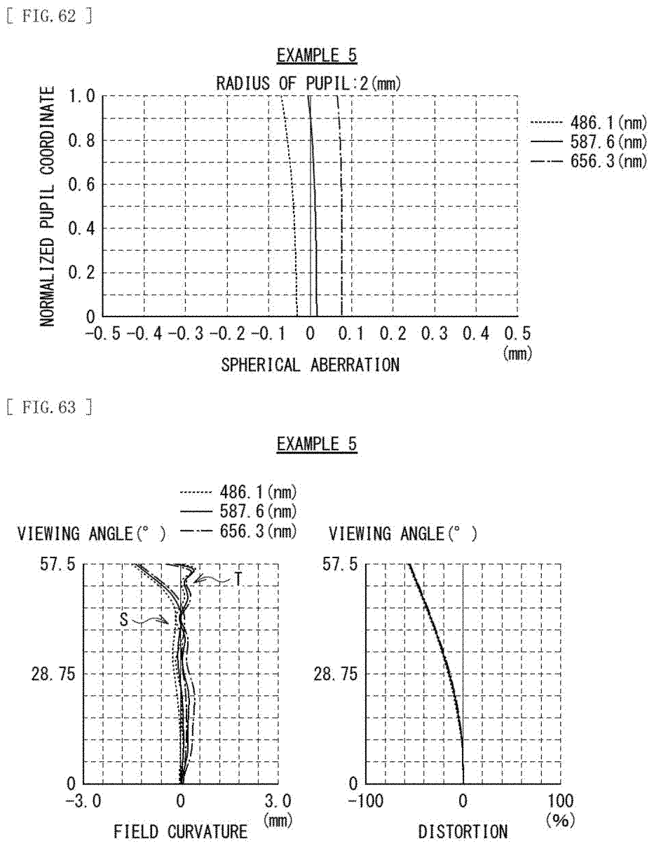

FIG. 61 illustrates a lens cross-section of the eyepiece according to Example 5. FIGS. 62 and 63 illustrate various aberrations of the eyepiece according to Example 5.

As can be appreciated from each of the aberration diagrams, it is apparent that the eyepiece according to Example 5 has a favorable optical performance.

### Example 6

Table 35 describes basic lens data of the eyepiece according to Example 6. Further, Table 36 and Table 37 describe aspherical surface data. Table 36 describes the aspherical surface data of standard lens surfaces. Table 37 describes the aspherical surface data of Fresnel lens surfaces.

TABLE 35
Example 6 Lens Data

| Si | | Ri | | Ndi | vdi |
|---|---|---|---|---|---|
| Surface | | Curvature | Di | Refractive | Abbe's |
| number | COMMENT | radius | Spacing | index | number |
| 1 | E.P. (Stop) | ∞ | 13 | — | — |
| 2 | Standard | 26.227 | 3.25 | 1.535 | 55.7 |
| | lens surface | | | | |
| 3 | Fresnel | −36.475 | 0.50 | — | — |
| | lens surface | | | | |
| 4 | Fresnel | 980.000 | 3.15 | 1.535 | 55.7 |
| | lens surface | | | | |
| 5 | Standard | −24.835 | 15.31 | — | — |
| | lens surface | | | | |
| 6 | Image plane | ∞ | — | — | — |

TABLE 36
Example 6 Aspherical Surface Data of Standard Lens Surfaces

| Si | K | 4th order | 6th order | 8th order |
|---|---|---|---|---|
| 2 | −4.98710E−01 | −5.55678E−05 | 3.62579E−08 | −4.62623E−11 |
| 5 | −7.43507E−01 | 7.67078E−05 | −1.08946E−07 | 3.11411E−11 |
| Si | 10th order | 12th order | 14th order | 16th order |
| 2 | 1.01901E−13 | −2.51166E−17 | — | — |
| 5 | 4.45405E−14 | — | — | — |

TABLE 37
Example 6 Aspherical Surface Data of Fresnel Lens Surfaces

| Si | K | 4th order | 6th order | 8th order |
|---|---|---|---|---|
| 3 | −1.84330E+00 | −1.33256E−06 | −1.13080E−07 | 1.92297E−10 |
| 4 | 0.00000E+00 | 8.04440E−05 | −6.05421E−08 | −4.17017E−11 |
| Si | 10th order | 12th order | 14th order | 16th order |
| 3 | −1.50827E−13 | 1.01422E−16 | — | — |
| 4 | 4.63312E−14 | 3.56364E−17 | — | — |

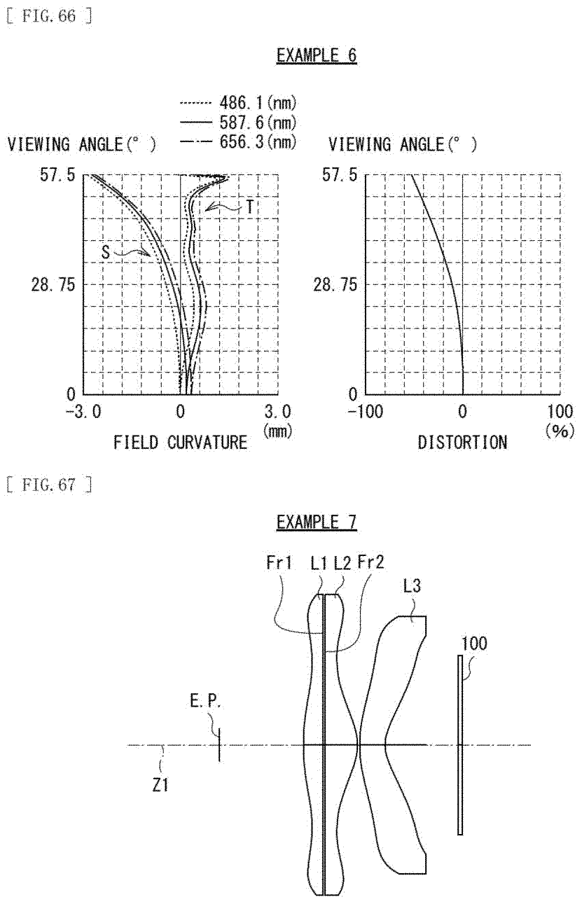

FIG. 64 illustrates a lens cross-section of the eyepiece according to Example 6. FIGS. 65 and 66 illustrate various aberrations of the eyepiece according to Example 6.

As can be appreciated from each of the aberration diagrams, it is apparent that the eyepiece according to Example 6 has a favorable optical performance.

### Example 7

Table 38 describes basic lens data of the eyepiece according to Example 7. Further, Table 39 and Table 40 describe aspherical surface data. Table 39 describes the aspherical surface data of standard lens surfaces. Table 40 describes the aspherical surface data of Fresnel lens surfaces.

TABLE 38
Example 7 Lens Data

| Si | | Ri | | Ndi | vdi |
|---|---|---|---|---|---|
| Surface | | Curvature | Di | Refractive | Abbe's |
| number | COMMENT | radius | Spacing | index | number |
| 1 | E.P. (Stop) | ∞ | 13 | — | — |
| 2 | Standard | 31.818 | 3.00 | 1.535 | 55.7 |
| | lens surface | | | | |
| 3 | Fresnel | −128.596 | 0.50 | — | — |
| | lens surface | | | | |
| 4 | Fresnel | 128.596 | 5.00 | 1.535 | 55.7 |
| | lens surface | | | | |
| 5 | Standard | −7.283 | 0.30 | — | — |
| | lens surface | | | | |
| 6 | Standard | 22.228 | 3.95 | 1.661 | 20.4 |
| | lens surface | | | | |
| 7 | Standard | 5.787 | 12.00 | — | — |
| | lens surface | | | | |
| 8 | Image plane | ∞ | — | — | — |

TABLE 39
Example 7 Aspherical Surface Data of Standard Lens Surfaces

| Si | K | 4th order | 6th order | 8th order |
|---|---|---|---|---|
| 2 | −2.40301E−01 | −4.12413E−05 | −9.56651E−08 | 4.47337E−10 |
| 5 | −6.18813E+00 | 4.89292E−05 | −2.32754E−08 | −6.62664E−11 |
| 6 | 0.00000E+00 | −7.41675E−05 | 2.58716E−08 | 5.20589E−11 |
| 7 | −5.17886E+00 | 3.89460E−06 | −1.63655E−07 | −7.52640E−11 |
| Si | 10th order | 12th order | 14th order | 16th order |
| 2 | −5.81420E−13 | 2.90744E−16 | — | — |
| 5 | 3.48374E−14 | — | — | — |
| 6 | 7.60278E−14 | 1.41028E−16 | 6.09508E−20 | −1.27574E−21 |
| 7 | 7.85668E−13 | 3.52998E−15 | 1.58195E−18 | −2.34214E−20 |

TABLE 40
Example 7 Aspherical Surface Data of Fresnel Lens Surfaces

| Si | K | 4th order | 6th order | 8th order |
|---|---|---|---|---|
| 3 | −7.42695E+00 | −5.68724E−05 | −2.37616E−08 | 1.31710E−10 |
| 4 | 7.42695E+00 | 5.68724E−05 | 2.37616E−08 | −1.31710E−10 |
| Si | 10th order | 12th order | 14th order | 16th order |
| 3 | −1.17119E−13 | 1.12498E−16 | — | — |
| 4 | 1.17119E−13 | −1.12498E−16 | — | — |

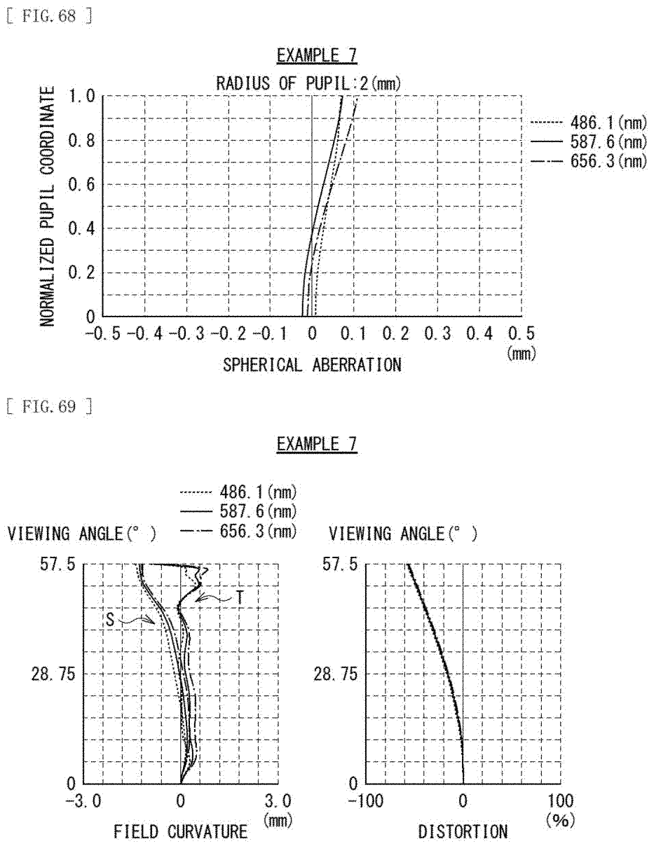

FIG. 67 illustrates a lens cross-section of the eyepiece according to Example 7. FIGS. 68 and 69 illustrate various aberrations of the eyepiece according to Example 7.

As can be appreciated from each of the aberration diagrams, it is apparent that the eyepiece according to Example 7 has a favorable optical performance.

### Example 8

Table 41 describes basic lens data of the eyepiece according to Example 8. Further, Table 42 and Table 43 describe aspherical surface data. Table 42 describes the aspherical surface data of standard lens surfaces. Table 43 describes the aspherical surface data of Fresnel lens surfaces.

TABLE 41
Example 8 Lens Data

| Si | | Ri | | Ndi | vdi |
|---|---|---|---|---|---|
| Surface | | Curvature | Di | Refractive | Abbe's |
| number | COMMENT | radius | Spacing | index | number |
| 1 | E.P. (Stop) | ∞ | 13 | — | — |
| 2 | Fresnel | 15.732 | 2.00 | 1.544 | 56.1 |
| | lens surface | | | | |
| 3 | Fresnel | −39.890 | 0.50 | — | — |
| | lens surface | | | | |
| 4 | Fresnel | 647.241 | 2.00 | 1.544 | 56.1 |
| | lens surface | | | | |
| 5 | Standard | 79.169 | 0.50 | — | — |
| | lens surface | | | | |
| 6 | Standard | 52.829 | 4.45 | 1.661 | 20.4 |
| | lens surface | | | | |
| 7 | Standard | 406.023 | 13.47 | — | — |
| | lens surface | | | | |
| 8 | Image plane | ∞ | — | — | — |

TABLE 42
Example 8 Aspherical Surface Data of Standard Lens Surfaces

| Si | K | 4th order | 6th order | 8th order |
|---|---|---|---|---|
| 5 | 1.17123E+01 | 1.69375E−05 | −3.32067E−08 | −5.22324E−11 |
| 6 | 4.51398E+00 | 2.96926E−05 | 4.98356E−08 | −1.69337E−12 |
| 7 | 0.00000E+00 | 9.17425E−05 | −5.64644E−08 | −2.03682E−10 |
| Si | 10th order | 12th order | 14th order | 16th order |
| 5 | −4.20759E−14 | 5.05320E−17 | — | — |
| 6 | −2.08173E−13 | −6.56148E−16 | — | — |
| 7 | −2.49522E−13 | 3.33893E−16 | — | — |

TABLE 43
Example 8 Aspherical Surface Data of Fresnel Lens Surfaces

| Si | K | 4th order | 6th order | 8th order |
|---|---|---|---|---|
| 2 | −4.29877E+00 | −5.11589E−05 | 2.44962E−08 | 1.01827E−10 |
| 3 | 2.14762E+00 | −7.14546E−05 | 2.04309E−07 | −2.09290E−10 |
| 4 | 0.00000E+00 | 8.87273E−05 | −1.31048E−07 | 4.38720E−11 |
| Si | 10th order | 12th order | 14th order | 16th order |
| 2 | −7.24709E−15 | −2.27601E−17 | — | — |
| 3 | −3.54250E−13 | 1.11215E−15 | — | — |
| 4 | 1.41268E−13 | −2.34882E−16 | — | — |

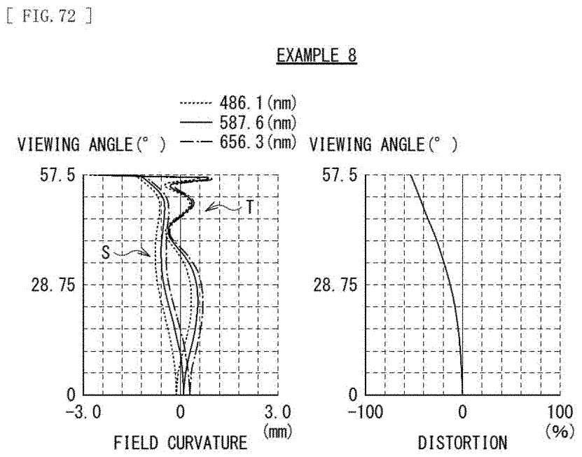

FIG. 70 illustrates a lens cross-section of the eyepiece according to Example 8. FIGS. 71 and 72 illustrate various aberrations of the eyepiece according to Example 8.

As can be appreciated from each of the aberration diagrams, it is apparent that the eyepiece according to Example 8 has a favorable optical performance.

### Other Numerical Data of Each Example

Table 44 and Table 45 describe a summary, for each Example, of various characteristics satisfied by the eyepiece according to each Example. Table 44 and Table 45 describe, as the various characteristics, values of: h (the maximum image height, the half value of the diagonal size of the image display device 100); L (the total length, the distance from the eye point E.P. to the image (the image display device 100)); ω (the half angle of view); E.R. (the eye relief); and My (the image magnification). In addition, Table 44 and Table 45 describe, as the various characteristics: the number of Fresnel lenses; a shape of the surface L1(R1), of the first lens L1, on the eye point E.P. side; a disposing manner of the first Fresnel lens surface Fr1 and the second Fresnel lens surface Fr2; a sign of refractive power of the first Fresnel lens surface Fr1 and the second Fresnel lens surface Fr2; and presence or absence of an aspherical lens having an inflection point. In addition, Table 44 and Table 45 describe, as the various characteristics, values of: a refractive index nd1 of the first lens L1 with respect to the d-line; a refractive index nd2 of the second lens L2 with respect to the d-line; refractive power ψ1 of the first Fresnel lens surface Fr1; and refractive power ψ2 of the second Fresnel lens surface Fr2. In addition, Table 44 and Table 45 describe, as the various characteristics, the values of d/L′, (ψ1+ψ2)/ψall, L1Φr1/Φd1, and L2Φr1/Φd2 regarding the foregoing conditional expressions (4) to (7). As described in Table 44 and Table 45, the eyepieces according to all of Examples satisfy the foregoing conditional expressions (1) to (3). The eyepieces according to Examples 5 to 8 further satisfy the foregoing conditional expressions (4) to (7).

TABLE 44

| | Example | Example | Example | Example | Example | Example | Example | Example |
|---|---|---|---|---|---|---|---|---|
| | 1-1 | 1-2 | 1-3 | 1-4 | 1-5 | 1-6 | 1-7 | 1-8 |
| h [mm] | 16.085 | 16.085 | 16.085 | 16.085 | 11.81 | 11.81 | 11.81 | 16.085 |
| L (Total | 35.11 | 36.75 | 33.34 | 34.29 | 32.49 | 32.19 | 30.33 | 35.697 |
| length) [mm] | | | | | | | | |
| ω (Half angle | 57.5 | 52.5 | 57.5 | 52.5 | 52.5 | 52.5 | 57.5 | 57.5 |
| of view) [°] | | | | | | | | |
| E.R. (Eye | 13 | 13 | 11 | 11 | 13 | 11 | 11 | 13 |
| relief) | | | | | | | | |
| Mv (Image | 2.34 | 2.22 | 2.23 | 2.10 | 2.63 | 2.61 | 2.70 | 2.37 |
| magnification) | | | | | | | | |
| Number of | 2 | 2 | 2 | 2 | 2 | 2 | 2 | 2 |
| Fresnel lens | | | | | | | | |
| Shape of | Convex | Convex | Convex | Convex | Convex | Convex | Convex | Planar |
| L1 (R1) | | | | | | | | |
| Disposing | Opposed | Opposed | Opposed | Opposed | Opposed | Opposed | Opposed | Opposed |
| manner of | | | | | | | | |
| Fresnel lens | | | | | | | | |
| surfaces | | | | | | | | |
| Refractive | + | + | + | + | + | + | + | + |
| power of | | | | | | | | |
| Fresnel lens | | | | | | | | |
| surfaces | | | | | | | | |
| Aspherical | Yes | Yes | Yes | Yes | Yes | Yes | Yes | Yes |
| lens with | | | | | | | | |
| inflection | | | | | | | | |
| point | | | | | | | | |
| nd1 | 1.5350 | 1.5350 | 1.5350 | 1.5350 | 1.5350 | 1.5350 | 1.5350 | 1.5350 |
| nd2 | 1.5350 | 1.5350 | 1.5350 | 1.5350 | 1.5350 | 1.5350 | 1.5350 | 1.5350 |
| ψ1 ≤ ψ2 | OK | OK | OK | OK | OK | OK | OK | OK |
| ψ1 | 0.0256 | 0.0218 | 0.0244 | 0.0228 | 0.0290 | 0.0226 | 0.0291 | 0.0306 |
| ψ2 | 0.0369 | 0.0295 | 0.0323 | 0.0288 | 0.0388 | 0.0277 | 0.0395 | 0.0419 |
| d/L′ | 0.782 | 0.729 | 0.774 | 0.743 | 0.687 | 0.713 | 0.688 | 0.688 |
| (ψ1 + ψ2)/ψall | 1.204 | 1.161 | 1.199 | 1.125 | 1.233 | 0.970 | 1.245 | 1.257 |
| LlΦr1/Φd1 | 0.108 | 0.141 | 0.112 | 0.142 | 0.105 | 0.139 | 0.101 | 0.092 |
| L2Φr1/Φd2 | 0.091 | 0.122 | 0.128 | 0.158 | 0.121 | 0.124 | 0.117 | 0.094 |

TABLE 45

| | Example | Example | Example | Example | Example | Example | Example |
|---|---|---|---|---|---|---|---|
| | 2 | 3 | 4 | 5 | 6 | 7 | 8 |
| h [mm] | 16.085 | 16.085 | 16.085 | 16.085 | 16.085 | 16.085 | 16.085 |
| L (Total length) [mm] | 37.97 | 41.19 | 42.31 | 37.54 | 37.25 | 37.747 | 36.028 |
| ω (Half angle of view) [°] | 57.5 | 55 | 55 | 57.5 | 57.5 | 57.5 | 57.5 |
| E.R. (Eye | 13 | 13 | 13 | 13 | 13 | 13 | 13 |
| relief) | | | | | | | |
| My (Image | 2.50 | 2.58 | 2.64 | 2.48 | 2.46 | 2.49 | 2.39 |
| magnification) | | | | | | | |
| Number of | 2 | 2 | 2 | 2 | 2 | 2 | 3 |
| Fresnel lens | | | | | | | |
| Shape of L1 | Convex | Convex | Convex | Convex | Convex | Convex | Convex |
| (R1) | | | | | | | |
| Disposing manner of | Opposed | Opposed | Opposed | Opposed | Opposed | Opposed | Opposed |
| Fresnel lens surfaces | | | | | | | |
| Refractive | + | + | + | + | + | + | + |
| power | | | | | | | |
| of Fresnel | | | | | | | |
| lens surfaces | | | | | | | |
| Aspherical | Yes | Yes | Yes | Yes | Yes | Yes | Yes |
| lens with | | | | | | | |
| inflection | | | | | | | |
| point | | | | | | | |
| nd1 | 1.5350 | 1.5350 | 1.5350 | 1.5350 | 1.5350 | 1.5350 | 1.5441 |
| nd2 | 1.5350 | 1.6612 | 1.6612 | 1.5350 | 1.5350 | 1.5350 | 1.5441 |
| ψ1 ≤ ψ2 | OK | OK | OK | OK | OK | OK | OK |
| ψ1 | 0.0343 | 0.0312 | 0.0292 | 0.0005 | 0.0005 | 0.0042 | 0.0008 |
| ψ2 | 0.0443 | 0.0424 | 0.0369 | 0.0574 | 0.0215 | 0.0735 | 0.0069 |
| d/L′ | 0.494 | 0.686 | 0.614 | 0.554 | 0.284 | 0.515 | 0.415 |
| (ψ1 + ψ2)/ | 1.176 | 1.582 | 1.175 | 0.202 | 0.283 | 0.172 | 0.277 |
| ψall | | | | | | | |
| L1Φr1/Φd1 | 0.086 | 0.525 | 0.507 | 0.174 | 0.140 | 0.226 | 0.144 |
| L2Φr1/Φd2 | 0.098 | 0.501 | 0.501 | 0.286 | 0.272 | 0.226 | 0.260 |

### 5. Other Embodiments

The technology according to the present disclosure is not limited to the description of the embodiments and Examples described above, and can be modified in variety of ways.

For example, the shapes and the numerical values of the respective parts described in each of the above numerical examples are each a mere example of implementation of the present technology, and the technical scope of the present technology should not be construed as being limited by these examples.

In addition, in the embodiments and Examples described above, the configuration substantially including three or four lenses has been described; however, a configuration further including a lens having substantially no refractive power or a lens having extremely-small refractive power may be adopted.

In each of the configuration examples described above, the annular-section height Rh of each of the annular sections 301 need not be fixed. For example, a forming method may be adopted in which a region close to the center of the lens has an increased annular-section height Rh to reduce the number of the annular sections in the central region of the field of view. Moreover, the annular-section pitch Rp may be fixed for each of the annular sections 301, and the annular-section height Rh for each of the annular sections 301 may be varied. Moreover, the annular-section height Rh and the annular-section pitch Rp may be randomly set for each of the annular sections 301.

Moreover, the first Fresnel lens surface Fr1 and the second Fresnel lens surface Fr2 need not be formed on a flat surface, and may be formed on a convex surface or a concave surface.

Moreover, in Examples 3 and 4, the first lens L1 and the second lens L2 may each have a lens part corresponding to the middle region forming the standard lens surface and a lens part corresponding to the peripheral region forming the Fresnel lens surface that include respective materials different from each other.

Moreover, for example, the present technology can adopt the following configurations.

According to the present technology having the following configurations, the configuration of the first lens and the second lens that are opposed to each other is optimized with use of the Fresnel lens. It is therefore possible to achieve a wide viewing angle and favorable aberration correction while reducing a weight and a total length.

[1]

An eyepiece including

a first lens and a second lens that are opposed to each other,

the first lens including a first Fresnel lens surface formed at least in a peripheral region of a lens surface that is opposed to the second lens,

the second lens including a second Fresnel lens surface formed at least in a peripheral region of a lens surface that is opposed to the first lens.

[2]

The eyepiece according to [1] described above, in which

Mv≥2.1 (1)

is satisfied, where My is an image magnification.

[3]

The eyepiece according to [1] or [2] described above, in which

the first lens is disposed closer to an eye point side than the second lens, and

the first lens includes an eye-point-side lens surface that has a convex shape or a planar shape.

[4]

The eyepiece according to any one of [1] to [3] described above, in which

the first Fresnel lens is formed from a center to a periphery of the lens surface, of the first lens, that is opposed to the second lens, and

the second Fresnel lens is formed from a center to a periphery of the lens surface, of the second lens, that is opposed to the first lens.

[5]

The eyepiece according to any one of [1] to [3] described above, in which

the first lens further includes a first non-Fresnel lens surface that is formed in a middle region of the lens surface that is opposed to the second lens, and

the second lens further includes a second non-Fresnel lens surface that is formed in a middle region of the lens surface that is opposed to the first lens.

[6]

The eyepiece according to any one of [1] to [5] described above, in which the eyepiece has a two-group two-lens configuration in which the first lens and the second lens are disposed in order from an eye point side toward an image side.

[7]

The eyepiece according to [6] described above, in which

the first Fresnel lens surface and the second Fresnel lens surface each have two or more annular sections,

the annular sections each have a border part on which a step surface is formed, and

the step surface on each of the first Fresnel lens surface and the second Fresnel lens surface has an angle, with respect to an optical axis, that is 15 degrees or greater.

[8]

The eyepiece according to any one of [1] to [5] described above, further including

a third lens that is disposed closer to an image side than the first lens and the second lens, in which

the eyepiece has a three-group three-lens configuration in which the first lens, the second lens, and the third lens are disposed in order from an eye point side toward the image side.

[9]

The eyepiece according to [8] described above, in which

the first Fresnel lens surface and the second Fresnel lens surface each have two or more annular sections,

the annular sections each have a border part on which a step surface is formed, and

the step surface on each of the first Fresnel lens surface and the second Fresnel lens surface has an angle, with respect to an optical axis, that is 20 degrees or greater.

[10]

The eyepiece according to any one of [1] to [9] described above, in which the first Fresnel lens surface and the second Fresnel lens surface each have positive refractive power.

[11]

The eyepiece according to any one of [1] to [10] described above, in which the first Fresnel lens surface, the second Fresnel lens surface, or both include an aspherical surface having an inflection point.

[12]

The eyepiece according to any one of [1] to [11] described above, in which

nd≤1.7 (2)

is satisfied, where nd is a refractive index of each of the first lens and the second lens with respect to a d-line.

[13]

The eyepiece according to any one of [1] to [12] described above, in which

ψ1≤ψ2 (3)

is satisfied, where

ψ1 is refractive power of the first Fresnel lens surface, and

ψ2 is refractive power of the second Fresnel lens surface.

[14]

The eyepiece according to any one of [1] to [4], [6], [8], and [10] to [13] described above, in which

0.2<d/L′<0.6 (4)

is satisfied, where

L′ is a distance from a most-eye-point-side lens surface to an image plane, and

d is a distance from the most-eye-point-side lens surface to a most-image-side lens surface.

[15]

The eyepiece according to any one of [1] to [4], [6], [8], and [10] to [14] described above, in which

(ψ1+ψ2)/ψall<0.30 (5)

is satisfied, where

ψ1 is refractive power of the first Fresnel lens surface,

ψ2 is refractive power of the second Fresnel lens surface, and

ψall is total refractive power of the eyepiece.

[16]

The eyepiece according to any one of [1] to [4], [6], [8], and [10] to [15] described above, in which

the first Fresnel lens surface and the second Fresnel lens surface each have two or more annular sections, and

0.1≤L1Φr1/Φd1 (6) and

0.2≤L2Φr1/Φd2 (7)

are satisfied, where

L1Φr1 is a diameter of a first annular section from a center of the first Fresnel lens surface,

Φd1 is an effective diameter of the first Fresnel lens surface,

L2Φr1 is a diameter of a first annular section from a center of the second Fresnel lens surface, and

Φd2 is an effective diameter of the second Fresnel lens surface.

[17]

The eyepiece according to any one of [1] to [4], [6], [8], and [10] to [16] described above, in which

the first Fresnel lens surface and the second Fresnel lens surface each have two or more annular sections, and

a pitch of the annular sections of the first Fresnel lens surface and a pitch of the annular sections of the second Fresnel lens surface are shifted from each other by a half period.

[18]

The eyepiece according to any one of [1] to [4], [8], and [10] to [17], in which the first lens includes a third Fresnel lens surface that is formed on an eye-point-side lens surface.

[19]

A display apparatus including:

an image display device; and

an eyepiece that magnifies an image displayed on the image display device,

the eyepiece including
a first lens and a second lens that are opposed to each other,
the first lens including a first Fresnel lens surface formed at least in a peripheral region of a lens surface that is opposed to the second lens, the first Fresnel lens surface having a Fresnel lens shape,
the second lens including a second Fresnel lens surface formed at least in a peripheral region of a lens surface that is opposed to the first lens, the second Fresnel lens surface having a Fresnel lens shape.
   [20]

The display apparatus according to [19] described above, in which the eyepiece has a lens diameter that is greater than a size of the image display device.

The present application claims priority based on Japanese Patent Application No. 2018-130078 filed with the Japan Patent Office on Jul. 9, 2018 and Japanese Patent Application No. 2019-44847 filed with the Japan Patent Office on Mar. 12, 2019, the entire contents of each which are incorporated herein by reference.

It should be understood that those skilled in the art would make various modifications, combinations, sub-combinations, and alterations depending on design requirements and other factors, and they are within the scope of the attached claims or the equivalents thereof.

1. An eyepiece comprising
a first lens and a second lens that are opposed to each other,
the first lens including a first Fresnel lens surface formed at least in a peripheral region of a lens surface that is opposed to the second lens,
the second lens including a second Fresnel lens surface formed at least in a peripheral region of a lens surface that is opposed to the first lens.

2. The eyepiece according to claim 1, wherein
Mv≥2.1 (1)
is satisfied, where My is an image magnification.

3. The eyepiece according to claim 1, wherein
the first lens is disposed closer to an eye point side than the second lens, and
the first lens includes an eye-point-side lens surface that has a convex shape or a planar shape.

4. The eyepiece according to claim 1, wherein
the first Fresnel lens is formed from a center to a periphery of the lens surface, of the first lens, that is opposed to the second lens, and
the second Fresnel lens is formed from a center to a periphery of the lens surface, of the second lens, that is opposed to the first lens.

5. The eyepiece according to claim 1, wherein
the first lens further includes a first non-Fresnel lens surface that is formed in a middle region of the lens surface that is opposed to the second lens, and
the second lens further includes a second non-Fresnel lens surface that is formed in a middle region of the lens surface that is opposed to the first lens.

6. The eyepiece according to claim 1, wherein the eyepiece has a two-group two-lens configuration in which the first lens and the second lens are disposed in order from an eye point side toward an image side.

7. The eyepiece according to claim 6, wherein
the first Fresnel lens surface and the second Fresnel lens surface each have two or more annular sections,
the annular sections each have a border part on which a step surface is formed, and
the step surface on each of the first Fresnel lens surface and the second Fresnel lens surface has an angle, with respect to an optical axis, that is 15 degrees or greater.

8. The eyepiece according to claim 1, further comprising
a third lens that is disposed closer to an image side than the first lens and the second lens, wherein
the eyepiece has a three-group three-lens configuration in which the first lens, the second lens, and the third lens are disposed in order from an eye point side toward the image side.

9. The eyepiece according to claim 8, wherein
the first Fresnel lens surface and the second Fresnel lens surface each have two or more annular sections,
the annular sections each have a border part on which a step surface is formed, and
the step surface on each of the first Fresnel lens surface and the second Fresnel lens surface has an angle, with respect to an optical axis, that is 20 degrees or greater.

10. The eyepiece according to claim 1, wherein the first Fresnel lens surface and the second Fresnel lens surface each have positive refractive power.

11. The eyepiece according to claim 1, wherein the first Fresnel lens surface, the second Fresnel lens surface, or both include an aspherical surface having an inflection point.

12. The eyepiece according to claim 1, wherein
nd≤1.7 (2)
is satisfied, where nd is a refractive index of each of the first lens and the second lens with respect to a d-line.

13. The eyepiece according to claim 1, wherein
ψ1≤ψ2 (3)
is satisfied, where
ψ1 is refractive power of the first Fresnel lens surface, and
ψ2 is refractive power of the second Fresnel lens surface.

14. The eyepiece according to claim 1, wherein
0.2<d/L′<0.6 (4)
is satisfied, where
L′ is a distance from a most-eye-point-side lens surface to an image plane, and
d is a distance from the most-eye-point-side lens surface to a most-image-side lens surface.

15. The eyepiece according to claim 1, wherein
(ψ+ψ2)/ψall<0.30 (5)
is satisfied, where
ψ1 is refractive power of the first Fresnel lens surface,
ψ2 is refractive power of the second Fresnel lens surface, and
ψall is total refractive power of the eyepiece.

16. The eyepiece according to claim 1, wherein
the first Fresnel lens surface and the second Fresnel lens surface each have two or more annular sections, and
0.1≤L1Φr1/Φd1 (6) and
0.2≤L2Φr1/Φd2 (7)
are satisfied, where
L1Φr1 is a diameter of a first annular section from a center of the first Fresnel lens surface,
Φd1 is an effective diameter of the first Fresnel lens surface,
L2Φr1 is a diameter of a first annular section from a center of the second Fresnel lens surface, and
Φd2 is an effective diameter of the second Fresnel lens surface.

17. The eyepiece according to claim 1, wherein
the first Fresnel lens surface and the second Fresnel lens surface each have two or more annular sections, and
a pitch of the annular sections of the first Fresnel lens surface and a pitch of the annular sections of the second Fresnel lens surface are shifted from each other by a half period.

18. The eyepiece according to claim 1, wherein the first lens includes a third Fresnel lens surface that is formed on an eye-point-side lens surface.

19. A display apparatus comprising:
an image display device; and
an eyepiece that magnifies an image displayed on the image display device,
the eyepiece including
a first lens and a second lens that are opposed to each other,
the first lens including a first Fresnel lens surface formed at least in a peripheral region of a lens surface that is opposed to the second lens, the first Fresnel lens surface having a Fresnel lens shape,
the second lens including a second Fresnel lens surface formed at least in a peripheral region of a lens surface that is opposed to the first lens, the second Fresnel lens surface having a Fresnel lens shape.

20. The display apparatus according to claim 19, wherein the eyepiece has a lens diameter that is greater than a size of the image display device.
